(19) United States
(12) Patent Application Publication
(10) Pub. No.: US 2025/0218091 A1
(43) Pub. Date: Jul. 3, 2025

(54) METHOD AND A SYSTEM FOR GENERATING AN IMAGINARY AVATAR OF AN OBJECT

(71) Applicant: Samsung Electronics Co., Ltd., Suwon-si (KR)

(72) Inventor: Natasha MEENA, Uttar Pradesh (IN)

(21) Appl. No.: 18/985,527

(22) Filed: Dec. 18, 2024

Related U.S. Application Data
(63) Continuation of application No. PCT/KR2023/010318, filed on Jul. 18, 2023.

(30) Foreign Application Priority Data
Sep. 6, 2022 (IN) 202211050929

(51) Int. Cl. G06T 13/40; G06T 7/11; G06T 7/50; G06T 7/73; G06T 13/20; G06V 10/764; G06V 10/82; G06V 20/50; G10L 13/02

(52) U.S. Cl. CPC G06T 13/40; G06T 7/11; G06T 7/50; G06T 7/73; G06T 13/205; G06V 10/764; G06V 10/82; G06V 20/50; G10L 13/02; G06T 2207/10016; G06T 2207/20084; G06T 2207/30201

(57) ABSTRACT

A method for generating an imaginary avatar of an object is disclosed. The method includes: determining at least one object detail from the object identified from an input content; determining a shape of the object based on the at least one object detail; determining a state of the object based on the input content and the at least one object detail; determining position of a plurality of physical features of the object based on the shape of the object; determining an emotion depicted by the object using the state of the object; and generating the imaginary avatar of the object based on the shape of the object, position of the plurality of physical features, and the determined emotion.

### CROSS-REFERENCE TO RELATED APPLICATIONS

This application is a continuation of International Application No. PCT/KR2023/010318, designating the United States, filed on Jul. 18, 2023, in the Korean Intellectual Property Receiving Office and claiming priority to Indian Patent Application No. 202211050929, filed on Sep. 6, 2022, in the Indian Patent Office, the disclosures of each of which are incorporated by reference herein in their entireties.

### BACKGROUND

### Field

The disclosure relates to the field of animation, and for example, relates to a method and a system for generating an imaginary avatar of an object.

### Description of Related Art

Traditionally, with the ongoing advances in metaverse, there is an increased interest of competitors towards integrating Augmented Reality (AR) and Virtual Reality (VR) in the traditional features. For example, avatar-based GIFs or stickers have taken a place parallel to the traditional emojis. However, there is still limited scope of avatar generation.

Limited target objects: Avatar creation and usage mostly revolves around “animal” creatures, like humans, cat, dogs, etc.
Ongoing trends in making the sharable avatars:
User clicks a picture of himself:

An avatar may be created with features best matching to picture (Contextual/statistical analysis of picture).

A cartoon sticker, an emote is generated (media creation is based on using Vison Application Programming Interfaces (APIs) from OpenCV).

Emoji/Graphics Interchange Format (GIF) closest matching to the picture (contextual or statistical analysis of picture) is suggested.

Media filters in video call—A filter is applied in real time to user's face such that cartoon of the face is created (Face recognition and feature extraction).

A generalized way of Avatar Generation: Uses “Area per unit information” which is obtained from pixelated version of the Animated version of avatar. The area per unit information is used to take information about the shape of the object. The information is then proportionated to determine the pose of the features. To give an imaginary look, the avatar is provided a number of imaginary features at the determined pose like eyes, mouth, hands and legs.

Existing Solutions: An existing solution makes an avatar of a user and generates media(s) for the user. The avatar is generated by taking a picture of user and assigning the best matching features from the set of existing ones to the avatar. The avatar formation takes into account real-world like appearance of object such as a real-world like human. Another existing solution makes Avatar of a user from an image. The avatar formation only works for three types of object—human (Male, Female) and Children (Infants).

Real World like Avatar is more explored than imaginary Avatars: The avatars generated from existing solutions focus more on making the avatars look closer to the real world like appearance. As a result, only humans or animal-like objects are targeted, and they are made to look like real world appearance. Attempt to make imaginary avatars is not explored in the existing solutions. For example, an image of a plant or a book may be converted into a cartoon image too and may be given features like eyes, nose, mouth, hands and legs; contradicting the real world appearance—hence “Imaginary Avatars”.

The media(s)/avatar created from any of the existing solutions provide solution for limited range of objects—more commonly human-like. A greater range of avatar categories or object classes for which avatar may be formed can be increased tremendously.
Existing Products/Solutions Limitations:

Limited Object Types: There is still limited scope of Avatar generation. Avatar creation and usage mostly revolves around “animal” creatures, like humans, cat, dogs, etc.
Customization versus Imagination: There is a need of taking Avatar's usage beyond the “real-world like appearance” to “imaginary appearance”
Existing Technology Solution:

Imaginary Information Determination: The current technology lacks a determination and addition of imaginary information to the avatar.

Generalized way of feature pose location: Object specific features are provided to the avatars to make them look real-world like. However, a generalized way to provide imaginary features to a wider range of non-conventional objects is unexplored.

A prior art discloses methods for generating a hybrid reality environment of real and virtual objects Two objects are considered and their features are overlapped. As an instance a tiger and a human will become a human faced tiger in a hybrid reality.

Another prior art discloses system and method for generating a virtual content to a physical object is described. Another prior art discloses methods for generating one or more AR objects corresponding to the one or more target objects, based at least in part on the digital image.

There is a need of taking avatar's usage beyond the “real-world like appearance” to “imaginary appearance”. For example, giving imaginary features like eyes, mouth to plants/books.

There is a need for a solution to address the above-mentioned drawbacks.

### SUMMARY

Embodiments of the disclosure provide a method and system for generating an imaginary avatar of an object.

In accordance with an example embodiment of the present disclosure, a method for generating an imaginary avatar of an object is disclosed. The method includes: determining at least one object detail from the object identified from an input content; determining a shape of the object based on the at least one object detail; determining a state of the object based on the input content and the at least one object detail; determining a position of a plurality of physical features of the object based on the shape of the object; determining an emotion depicted by the object using the state of the object; and generating the imaginary avatar of the object based on the shape of the object, position of the plurality of physical features, and the determined emotion.

In accordance with an example embodiment of the present disclosure, a system for generating an imaginary avatar of an object is disclosed. The system includes: a detail determining unit comprising circuitry configured to determine at least one object detail from the object identified from an input content; a shape determining unit comprising circuitry configured to determine a shape of the object based on the at least one object detail; a state determining unit comprising circuitry configured to determine a state of the object based on the input content and the at least one object detail; a position determining unit comprising circuitry configured to determine position of a plurality of physical features of the object based on the shape of the object; an emotion determining unit comprising circuitry configured to determine an emotion depicted by the object using the state of the object; and a generating unit comprising circuitry configured to generate the imaginary avatar of the object based on the shape of the object, position of the plurality of physical features, and the determined emotion.

These aspects and advantages will be more clearly understood from the following detailed description taken in conjunction with the accompanying drawings.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a flowchart illustrating an example method for generating an imaginary avatar of an object, according to various embodiments;

FIG. 2 is a block diagram illustrating an example configuration of a system configured to generate an imaginary avatar of an object, according to various embodiments;

FIG. 3 is an operational flow diagram illustrating an example process for generating an imaginary avatar of an object, according to various embodiments;

FIG. 4 is a diagram illustrating an example method of generating an imaginary avatar of an object, according to various embodiments;

FIG. 5A is an operational flow diagram illustrating an example process for object information processing, according to various embodiments;

FIG. 5B is a diagram illustrating example object recognition, according to various embodiments;

FIG. 5C is a diagram illustrating example object information text formation, according to various embodiments;

FIG. 6A is an operational flow diagram illustrating an example process for an object shape and state detection, according to various embodiments;

FIG. 6B is a diagram illustrating an example state determination model, according to various embodiments;

FIG. 6C is a diagram illustrating an example architecture of the state determination model, according to various embodiments;

FIG. 6D is a diagram illustrating example generation of the animated image of the target image in the object shape detection, according to various embodiments;

FIG. 6E is a diagram illustrating example object edge detection in the object shape detection, according to various embodiments;

FIG. 6F is a diagram illustrating an example pre-trained state determination model used in the object state detection, according to various embodiments;

FIG. 6G is a diagram illustrating example state score determination in the object state detection, according to various embodiments;

FIG. 7A is an operational flow diagram illustrating an example process for an imaginary information generation, according to various embodiments;

FIG. 7B is a diagram illustrating examples of pose determination, according to various embodiments;

FIG. 7C is a diagram illustrating example area per unit width, according to various embodiments;

FIG. 7D is a diagram illustrating an example process for imaginary features generation, according to various embodiments;

FIG. 7E is a diagram illustrating an example process for imaginary emotion generation, according to various embodiments;

FIG. 8A is an operational flow diagram illustrating an example process for an avatar motion controller, according to various embodiments;

FIG. 8B is a diagram illustrating example avatar motion control, according to various embodiments;

FIG. 8C is a diagram illustrating example facial trajectory control, according to various embodiments;

FIG. 8D is a diagram illustrating example joints trajectory control, according to various embodiments;

FIGS. 8E and 8F are diagrams illustrating example ways of bending imaginary hands of the object, according to various embodiments;

FIG. 8G is a diagram illustrating various example ways of joints movement, according to various embodiments;

FIGS. 8H and 8I are diagrams illustrating example imaginary avatar generated after motion control, according to various embodiments;

FIGS. 9A, 9B, 9C, 9D and 9E are diagrams illustrating an example method for generating an imaginary avatar, according to various embodiments;

FIG. 10 is a diagram illustrating a use case illustrating an example scenario for generating an imaginary avatar for an object, according to various embodiments;

FIG. 11 is a diagram illustrating a use case illustrating example generation of an imaginary avatar in a meta verse, according to various embodiments;

FIG. 12A is a diagram illustrating example imaginary avatar generation, according to various embodiments;

FIG. 12B is a use case diagram illustrating example imaginary avatar generation, according to the prior art;

FIG. 13 is a use case diagram illustrating an example smarter home, according to various embodiments;

FIG. 14 is a use case diagram illustrating an example metaverse with more imagination, according to various embodiments;

FIG. 15 is a use case diagram illustrating an example smart food guide, according to various embodiments;

FIG. 16 is a use case diagram illustrating an example aspect ratio guide, according to various embodiments;

FIG. 17 is a diagram illustrating an example imaginary avatar of objects, according to various embodiments;

FIGS. 18A and 18B are diagrams illustrating example use case scenarios, according to various embodiments; and

FIGS. 19A and 19B are diagrams illustrating example generation of imaginary avatar according to various embodiments and the prior art respectively.

FIG. 20 is a diagram illustrating example method of obtaining animated image of the target object according to various embodiments.

FIG. 21 is a diagram illustrating example method of post processing according to various embodiments.

FIG. 22 is a diagram illustrating example of area of the shape of object in one row according to various embodiments.

FIGS. 23 and 24 are diagrams illustrating example of pixelating the image and determining the Columns where the pixel value has edge according to various embodiments.

FIGS. 25 and 26 are diagrams illustrating example method of handling in calculation of area according to various embodiments.

FIGS. 27 and 28 are diagrams illustrating exemplary depiction according to various embodiments.

FIG. 29 is a diagram illustrating example depiction of head and body according to various embodiments.

FIG. 30 is a diagram illustrating example depiction of eyes, mouth, hands and legs according to various embodiments.

Further, skilled artisans will appreciate that elements in the drawings are illustrated for simplicity and may not have been necessarily drawn to scale. For example, the flowcharts illustrate the system in terms of the steps involved to help to improve understanding of aspects of the present disclosure. Furthermore, in terms of the construction of the device, one or more components of the device may have been represented in the drawings by conventional symbols, and the drawings may show those specific details that are pertinent to understanding the various embodiments of the present disclosure so as not to obscure the drawings with details that will be readily apparent to those of ordinary skill in the art having benefit of the description herein.

### DETAILED DESCRIPTION

For the purpose of promoting an understanding of the principles of the disclosure, reference will now be made to various example embodiments illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated herein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment” and similar language throughout this disclosure may, but do not necessarily, all refer to the same embodiment.

The terms “comprises”, “comprising”, or any other variations thereof, are intended to cover a non-exclusive inclusion, such that a process or system that comprises a list of steps does not include only those steps but may include other steps not expressly listed or inherent to such process or system. Similarly, one or more devices or sub-systems or elements or structures or components proceeded by “comprises. a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this disclosure belongs. The system, systems, and examples provided herein are illustrative only and not intended to be limiting.

Embodiments of the present disclosure are described below in greater detail with reference to the accompanying drawings.

It should be noted that imaginary avatar motion control referred throughout the disclosure includes a combination of generating unit and motion controller.

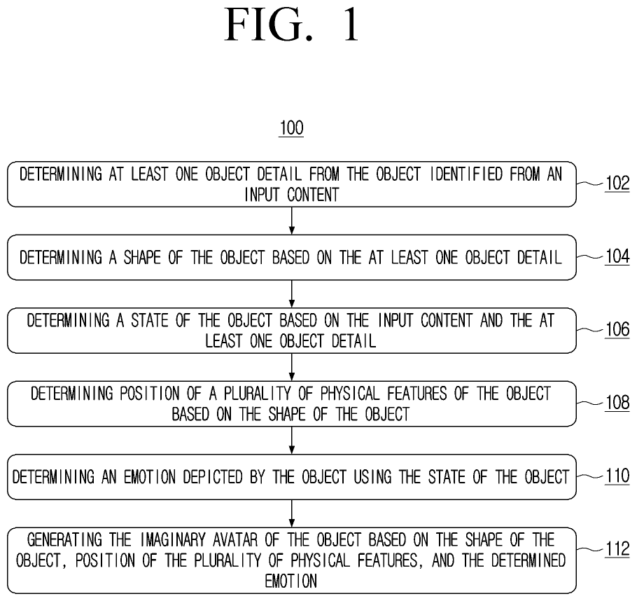

FIG. 1 is a flowchart illustrating an example method 100 for generating an imaginary avatar of an object, according to various embodiments.

As shown in FIG. 1, at step 102, the method 100 includes determining at least one object detail from the object identified from an input content.

At step 104, the method 100 includes determining a shape of the object based on the at least one object detail.

At step 106, the method 100 includes determining a state of the object based on the input content and the at least one object detail.

At step 108 the method 100 includes determining position of a plurality of physical features of the object based on the shape of the object.

At step 110, the method 100 includes determining an emotion depicted by the object using the state of the object.

At step 112, the method 100 includes generating the imaginary avatar of the object based on the shape of the object, position of the plurality of physical features, and the determined emotion.

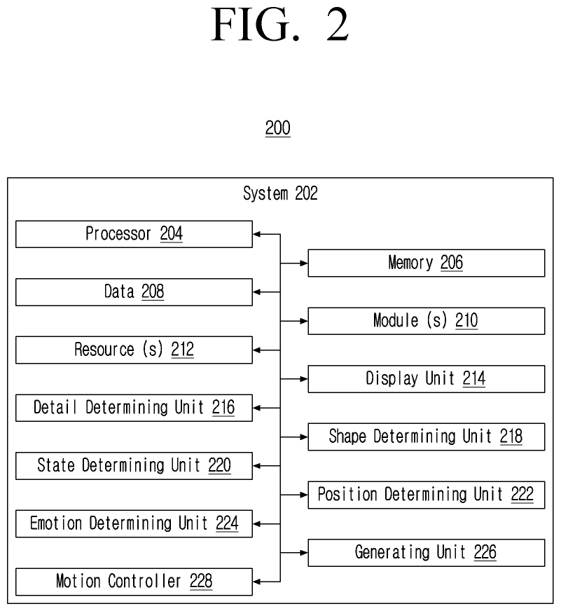

FIG. 2 is a block diagram 200 illustrating an example configuration of a system 202 configured to generate an imaginary avatar of an object, according to various embodiments. In an embodiment, the system 202 may be incorporated in a User Equipment (UE). Examples of the UE may include, but not limited to, a laptop, a tab, a smart phone, a Personal Computer (PC).

The system 202 may include a processor (e.g., including processing circuitry) 204, a memory 206, data 208, module (s) (e.g., including various circuitry and/or executable program instructions) 210, resource (s) 212, a display unit (e.g., including a display) 214, a detail determining unit (e.g., including various circuitry and/or executable program instructions) 216, a shape determining unit (e.g., including various circuitry and/or executable program instructions) 218, a state determining unit (e.g., including various circuitry and/or executable program instructions) 220, a position determining unit (e.g., including various circuitry and/or executable program instructions) 222, an emotion determining unit (e.g., including various circuitry and/or executable program instructions) 224, a generating unit (e.g., including various circuitry and/or executable program instructions) 226, and a motion controller (e.g., including various circuitry and/or executable program instructions) 228. In an embodiment, the processor 204, the memory 206, the data 208, the module (s) 210, the resource (s) 212, the display unit 214, the detail determining unit 216, the shape determining unit 218, the state determining unit 220, the position determining unit 222, the emotion determining unit 224, the generating unit 226, and the motion controller 228 may be communicatively coupled to one another.

As would be appreciated, the system 202, may be understood as one or more of a hardware, a software, a logic-based program, a configurable hardware, and the like. In an example, the processor 204 may be a single processing unit or a number of units, all of which could include multiple computing units. The processor 204 may be implemented as one or more microprocessors, microcomputers, microcontrollers, digital signal processors, central processing units, processor cores, multi-core processors, multiprocessors, state machines, logic circuitries, application-specific integrated circuits, field-programmable gate arrays and/or any devices that manipulate signals based on operational instructions. Among other capabilities, the processor 204 may be configured to fetch and/or execute computer-readable instructions and/or data stored in the memory 206. For example, the processor 204 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an example, the memory 206 may include any non-transitory computer-readable medium known in the art including, for example, volatile memory, such as static random access memory (SRAM) and/or dynamic random access memory (DRAM), and/or non-volatile memory, such as read-only memory (ROM), erasable programmable ROM (EPROM), flash memory, hard disks, optical disks, and/or magnetic tapes. The memory 206 may include the data 208. The data 208 serves, amongst other things, as a repository for storing data processed, received, and generated by one or more of the processors 204, the memory 206, the module (s) 210, the resource (s) 212, the display unit 214, the detail determining unit 216, the shape determining unit 218, the state determining unit 220, the position determining unit 222, the emotion determining unit 224, the generating unit 226, and the motion controller 228.

The module(s) 210, amongst other things, may include routines, programs, objects, components, data structures, etc., which perform particular tasks or implement data types. The module(s) 210 may also be implemented as, signal processor(s), state machine(s), logic circuitries, and/or any other device or component that manipulate signals based on operational instructions.

Further, the module(s) 210 may be implemented in hardware, as instructions executed by at least one processing unit, e.g., processor 204, or by a combination thereof. The processing unit may be a general-purpose processor that executes instructions to cause the general-purpose processor to perform operations or, the processing unit may be dedicated to performing the required functions. In another aspect of the present disclosure, the module(s) 210 may be machine-readable instructions (software) which, when executed by a processor/processing unit, may perform any of the described functionalities.

In various example embodiments, the module(s) 210 may be machine-readable instructions (software) which, when executed by a processor 204/processing unit, perform any of the described functionalities.

The resource(s) 212 may be physical and/or virtual components of the system 202 that provide inherent capabilities and/or contribute towards the performance of the system 202. Examples of the resource(s) 212 may include, but are not limited to, a memory (e.g., the memory 206), a power unit (e.g., a battery), a display unit (e.g., the display unit 214) etc. The resource(s) 212 may include a power unit/battery unit, a network unit, etc., in addition to the processor 204, and the memory 206.

The display unit 214 may include a display and display various types of information (for example, media contents, multimedia data, text data, etc.) to the system 202. The display unit 214 may include, but is not limited to, a liquid crystal display (LCD), a light-emitting diode (LED) display, an organic LED (OLED) display, a plasma cell display, an electronic ink array display, an electronic paper display, a flexible LCD, a flexible electrochromic display, and/or a flexible electrowetting display.

In an example, the detail determining unit 216, the shape determining unit 218, the state determining unit 220, the position determining unit 222, the emotion determining unit 224, the generating unit 226, and the motion controller 228 amongst other things, include routines, programs, objects, components, data structures, etc., which perform particular tasks or implement data types. The detail determining unit 216, the shape determining unit 218, the state determining unit 220, the position determining unit 222, the emotion determining unit 224, the generating unit 226, and the motion controller 228 may also be implemented as, signal processor(s), state machine(s), logic circuitries, and/or any other device or component that manipulate signals based on operational instructions. Further, the detail determining unit 216, the shape determining unit 218, the state determining unit 220, the position determining unit 222, the emotion determining unit 224, the generating unit 226, and the motion controller 228 can be implemented in hardware, instructions executed by a processing unit, or by a combination thereof. The processing unit can comprise a computer, a processor, such as the processor 204, a state machine, a logic array or any other suitable devices capable of processing instructions. The processing unit can be a general-purpose processor which executes instructions to cause the general-purpose processor to perform the required tasks or, the processing unit can be dedicated to performing the required functions.

Continuing with the above embodiment, the detail determining unit 216 may be configured to determine at least one object detail from the object. Examples of the at least one object detail may include, but are not limited to, a class of the object and a confidence score of the object. The object may be identified from an input content by the detail determining unit 216. The input object may be one of an image and a video.

Subsequent to determination of the at least object detail by the detail determining unit 216, the shape determining unit 218 may be configured to determine a shape of the object based on the at least one object detail. For determining the shape, the shape determining unit 218 may be configured to determine an animated image of the object. Upon determining the animated image, the shape determination unit may be configured to determine edges of the object from the animated image of the object. Subsequently, the shape determination unit may be configured to determine the shape of the object based on the edges of the object.

Moving forward, in response to determination of the shape by the shape determining unit 218, the state determining unit 220 may be configured to determine a state of the object. The state of the object may be determined based on the input content and the at least one object detail. The shape determining unit 218 may be configured to determine the state of the object using a pre-trained neural network model.

Continuing with the above embodiment, the position determining unit 222 may be configured to determine a position of a number of physical features of the object. Examples of the number of physical features may include, but are not limited to, at least two of eyes, ears, hair, lip, mouth, nose, hands and legs. The position of each of the number of physical features may be determined based on the shape of the object. For determining the position of the number of physical features, the position determining unit 222 may be configured to derive an area per unit information of the object from the detected shape of the object. Moving forward, the position determining unit 222 may be configured to segment the object in an upper part and a lower part based on the area per unit information. In response to segmenting the object, the position determining unit 222 may be configured to determine the position of the plurality of physical features in the upper and lower part of the object.

Subsequently, the emotion determining unit 224 may be configured to determine an emotion depicted by the object using the state of the object. The emotion determination unit may be configured to determine the emotion from a group of predefined emotions based on the state of the object.

The generating unit may be configured to generate the imaginary avatar of the object based on the shape of the object, the position of the plurality of physical features, and the determined emotion. For generating the imaginary avatar, the generating unit 226 may be configured to place the plurality of physical features based on determined position, on the shape of the object. Continuing with the above embodiment, the generating unit 226 may be configured to impose the emotion on the plurality of physical features. Further, the generating unit 226 may be configured to determine background information of the object. Moving forward, the generating unit 226 may be configured to generate the imaginary avatar of the object based on the background information.

In an embodiment, the detail determining unit 216 may further be configured to determine textual information about the object using the at least one object detail. Upon generation of the textual information, the generating unit 226 may be configured to convert the textual information into a speech. In response to generating the speech from the textual information, the generating unit 226 may further be configured to generate an audio for the imaginary avatar using the converted speech. Further, the motion controller 228 may be configured to animate the imaginary avatar by controlling motion of the plurality of physical features of the imaginary avatar in sync with the generated audio.

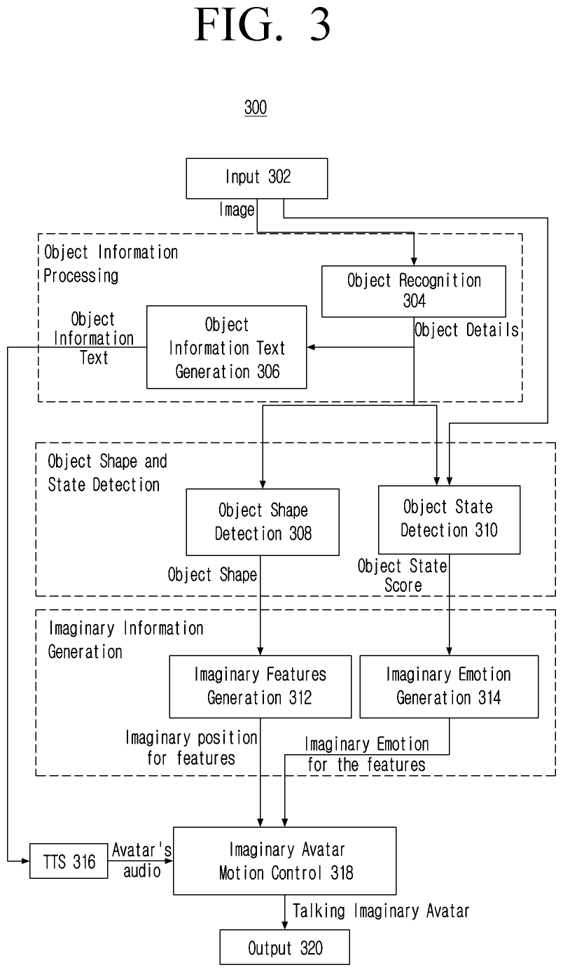

FIG. 3 is an operational flow diagram illustrating an example process 300 for generating an imaginary avatar of an object, according to various embodiments, the process 300 may performed by the system 202 as referred in FIG. 2. Further, the system 202 may be incorporated in a User Equipment (UE). Examples of the UE may include, but not limited to, a laptop, a tab, a smart phone, a Personal Computer (PC).

At step 302, the process 300 may include considering an image in the system 202 as an input. The image may contain a target object. In an exemplary embodiment, the target object may be a plant. The target object may be an object as referred in FIG. 2. The image may be considered as the input by the processor 204 as referred in FIG. 2.

At step 304, the process 300 may include processing the image to detect and recognize the target object present in the image considered as the input. Further, a class of the target object may be determined and referred as at least one object detail related to the target object. The target object and the at least one detail may be determined by the detail determining unit 216 as referred in FIG. 2. In other words, this step may be performed by detail determining unit 216. In an example embodiment, the at least one object detail may contain information such as a class of a plant where the plant is the target plant such as a peace lily with a confidence score of 95%.

At step 306, the process 300 may include using the at least one object detail to determine an object information text. In an example embodiment, the object information text may be detailed information about the target object in a first person format. Continuing with the example embodiment, the object information text for an object class peace lily may be: “I am Peace Lily. I am an indoor plant. I like to stay moist.” The object information text may be determined by the detail determining unit 216.

At step 308, the process 300 may include processing an animated image of the target object to determine a shape associated with the target shape. The object shape may roughly be an outer edge of the target object. The shape may be determined by the shape determining unit 218 as referred in FIG. 2.

At step 310, the process 300 may include identifying a difference between the target object and an idle state associated with the target shape to determine a state of the target object. The state may be a measure of a condition of the target object. In an example embodiment, a drying or a rotting peace lily falls in a bad state, but a healthy and green peace lily may fall in a good state. A State of the target object may be determined by the state determining unit 220 as referred in FIG. 2 to determine the state of the target object.

At step 312, the process 300 may include determining area per unit information based on the state of the target shape. The area per unit information may further be used to determine an imaginary position for one or more features. The imaginary position may be determined by the position determining unit 222 as referred in FIG. 2. The one or more features may be a number of physical features of the target object. Examples of the number of physical features may include, but are not limited to, at least two of eyes, ears, hair, lip, mouth, nose, hands and legs. The imaginary position for the features may be generated by proportionating the area per unit information. In an exemplary embodiment, the imaginary position of the features may be determined for a peace lily, contradicting a real-world look.

At step 314, the process 300 may include determining an imaginary Emotion for the features such as happy, sad, angry, satisfied, overwhelmed, depressed, or the like. The imaginary emotion may be determined using the state of the object. In an example embodiment, a peace lily falling in good state may have an imaginary emotion of an admiration for a user. The imaginary emotion may be determined by the emotion determining unit 224 as referred in FIG. 2.

At step 316, the process 300 may include converting the object information text to speech by a Text to Speech (TTS) engine in order to get audio data associated with the imaginary avatar. The conversion may be performed by the generating unit 226 as referred in FIG. 2.

At step 318, the process 300 may include performing a motion control of the imaginary avatar to control a motion of facial features such as eyes, mouth, or the like and the joints of imaginary features such as hands, legs, etc. according to the audio data associated with the imaginary avatar. The motion control may be performed by the motion controller 228 as referred in FIG. 2.

At step 320, the process 300 may include generating an output as the imaginary avatar including the imaginary features such as eyes, mouth, hands, legs, or the like. The output may be generated by the generating unit 226.

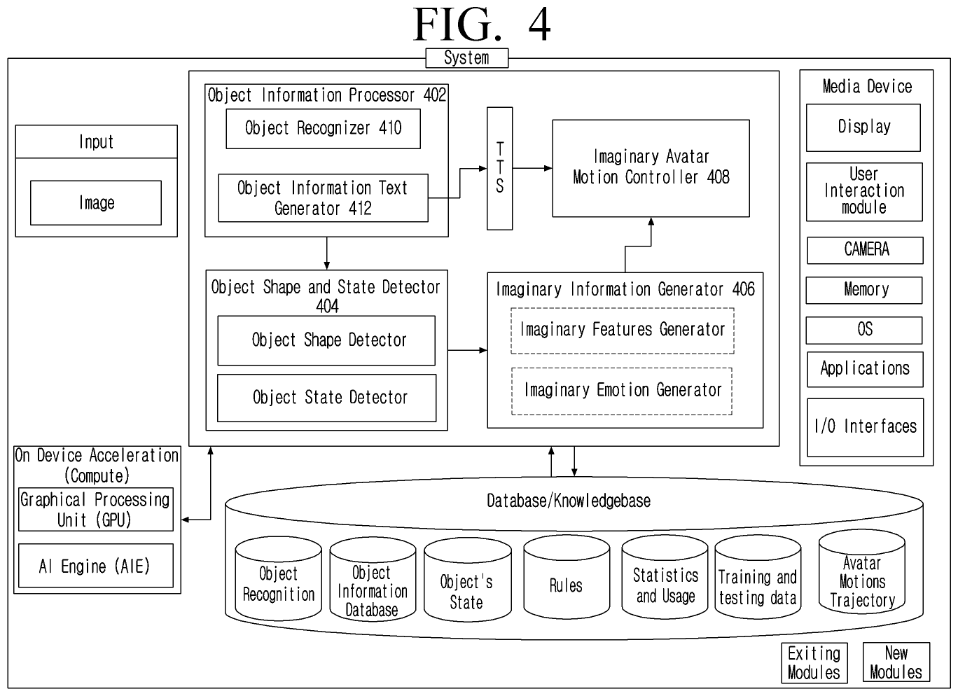

FIG. 4 is a diagram 400 illustrating an example method generating an imaginary avatar of an object, according to various embodiments. The architectural diagram may include an object information processor 402, an object shape and state detector 404, an imaginary information generator 406, and an imaginary avatar motion controller 408. The object information processor 402 may be the detail determining unit 216 as referred in FIG. 2 and may include an object recognizer 410, and an object information text generator 412. The object shape and state detector 404 may include an object shape detector and an object state detector. The object shape detector may be the shape determining unit 218 as referred in FIG. 2. The object state detector may be the state determining unit 220 as referred in FIG. 2. The imaginary information generator 406 may include an imaginary features generator, and an imaginary emotion generator. The imaginary features generator may be the position determining unit 222 as referred in FIG. 2. The imaginary emotion generator may be the emotion determining unit 224 as referred in FIG. 2. The imaginary avatar motion controller may be a combination of the generating unit 226 and the motion controller 228 as referred in FIG. 2, each of the above may include various circuitry and/or executable program instructions.

The object information processor may be configured to determine at least one object detail and information text associated with an object. The object may be identified from an input content and may be one of an image and a video. The object recognizer 410 may be configured to perform an object recognition to identify a class of the object and correspondingly a confidence score. Further, the object information text generator 412 may be configured to determine more detailed information about the object. The object information text generator 412 may further be configured to transform the more detailed information into a first-person format.

The object shape and state detector 404 may be configured to determine a shape and a state of the object. The object shape detector may be configured to determine a rough shape or edges of an outer boundary of the object. Further, the state detector may be configured to determine the state or a condition of the object. This is a measure of a closeness of the object and an ideal appearance of the object.

The imaginary information generator 406 may be configured to generate imaginary information for an animated version of the object. In an exemplary embodiment, non-conventional avatar objects such as plants, notebooks, pens, shoes or the like may be converted into a form of a cartoon.

The imaginary features generator may be configured to generate an imaginary position for one or more features of the object such as eyes, nose, mouth, hands and legs. The imaginary features generator may further be configured to provide a position of the one or more features on a non-animal like object. The imaginary emotion generator may be configured to generate an imaginary emotion for the one or more features of the imaginary avatar using information associated with the state of the object. The imaginary emotion generator may be configured to provide a happy emotion to the object in a good state and a sad emotion otherwise.

The avatar motion controller may be configured to generate an animation of the imaginary avatar. The animation of imaginary avatar may be performed by making lips move, or facial expression change and joints motion. A motion control by the avatar motion controller includes a trajectory control of mouth to make the lips sync with an audio of the imaginary avatar. The avatar motion controller may further be configured to perform a joints trajectory control for controlling the joints of hands and legs for making a communication between the imaginary avatar and a user more interactive.

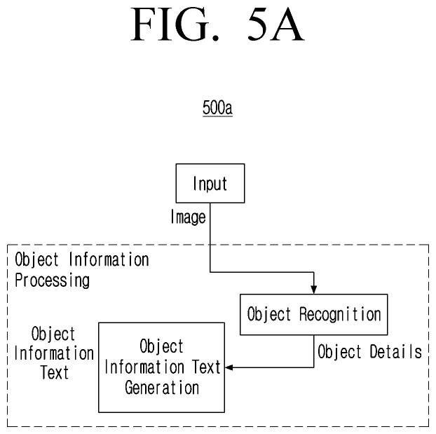

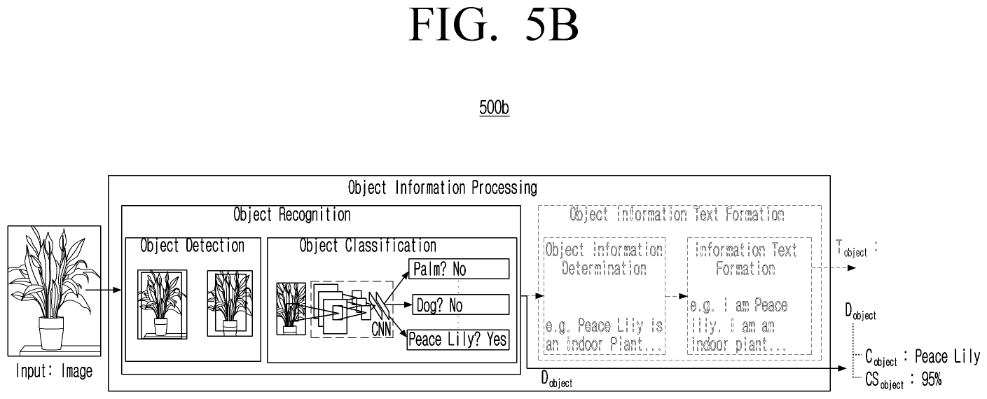

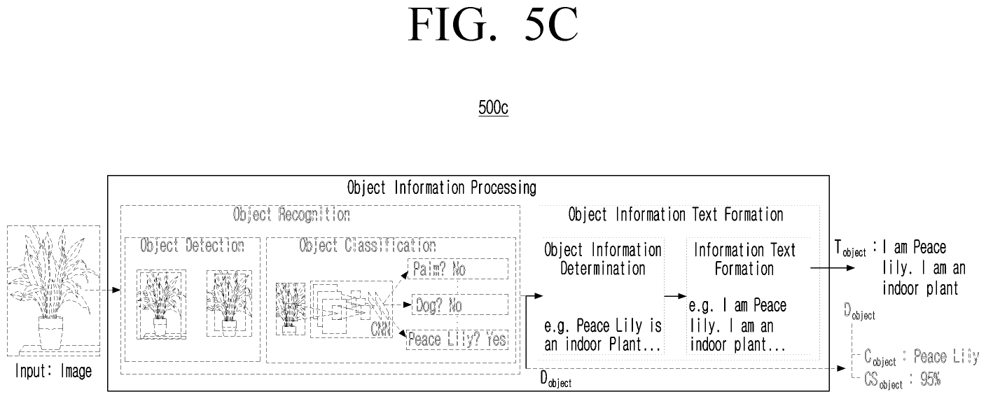

FIG. 5A is an operational flow diagram illustrating an example process 500a for an object information processing, according to various embodiments. In an embodiment, the process 500a may be performed by the detail determining unit 216 as referred in FIG. 2. The object information processing may be performed with respect to an object detected in an input. The object may interchangeably be referred as a target object. The input may be one of an image and a video. The object information processing may be performed in order to generate an imaginary avatar of the object detected in the input. An aim to perform the object information processing may be recognizing the target object in the input. The target object after object recognition, form an object information text using recognized object details.

The detail determination unit may be configured to receive the image as the input and generate the object details, D_{object} and the object information text, T_{object} as an output.

The object recognition includes two steps, for example, object detection and object classification. The object detection may be performed to detect region of the image that contain the target object. A class-independent region proposals is most commonly found using R-CNNs. As an example, the aim of object detection may be to prune the input image so as to discard the region that is not of interest for further processing.

Moving forward, having identified the class-independent region of the image, the region may further be processed using the CNNs to perform the object classification. In an example embodiment, an inception-based CNN architecture may also be used to classify the object into one of the 1000 classes it is trained for. Thus, the target object may be assigned a class C_{object} with a confidence score CS_{object} As an example, for the input image containing a plant, an object class: peace lily with 95% confidence score may be identified.

Thus, after the object classification is done. The object details D_{object} may be determined. The object details contain details about the target object as follows:
D_{object}
   C_{object}: Class of the target object
   CS_{object}: Confidence score the target object belonging to class C_{object}

The object information text formation may form the object information text, T_{object} using the recognized object details, D_{object}. The object information text formation includes an object information determination and a first-person text formation.

The object information determination: Based on the Class of the target object, C_{object}, the detailed object information may be needed to be determined. The object information includes information such as, but not limited to, name, species, origin, history, care instructions, manufacturer, age or the like. Any database may be used for determining the object information, such as—“peace lily is an indoor plant. It likes to stay moist . . . ”.

The first-person text formation: The object information, as obtained from the database, may be in third person. The first-person text formation may convert the third person text to the first person. The third person to the first-person conversion of text may be based on one of a rule-based approach and a GPT-2 based language model. As an example, the object information of database may be converted to the first-person text such as: “I am peace lily. I am an indoor plant. I like to stay moist.” Thus, the object information text, T_{object}, which is the first-person format of the object information, may be determined.

FIG. 5B is a diagram 500b illustrating example object recognition, according to various embodiments. The input image may be received, and the target object may be a plant. Based on object recognition, the object details D_{object} may be determined. The object details contain details about the target object as follows:
D_{object}
   Cobject: Peace Lily
   CSobject: 95%

FIG. 5C is a diagram 500c illustrating example object information text formation, according to various embodiments. The object details D_{object} may be received as an input and the first-person text formation may be performed to generate the object information text TOBJECT.

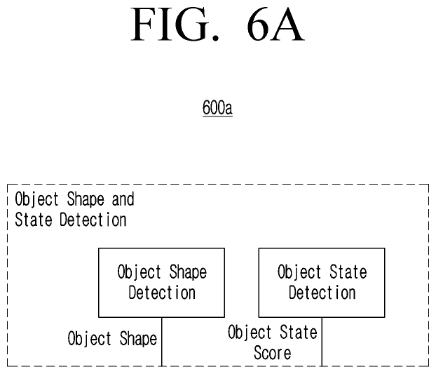

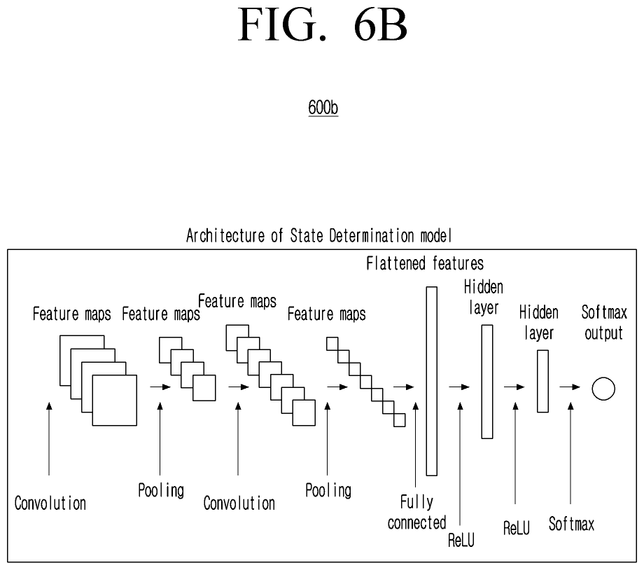

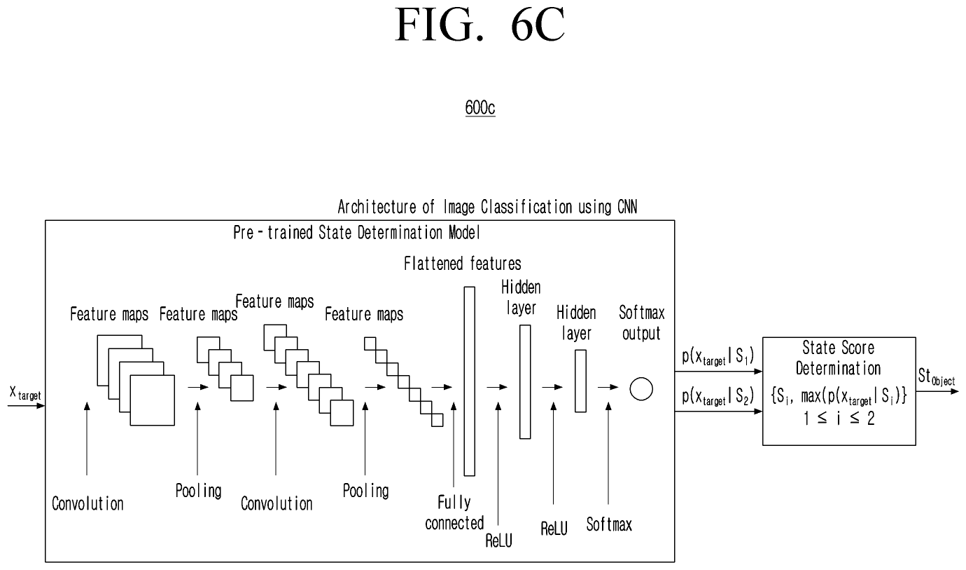

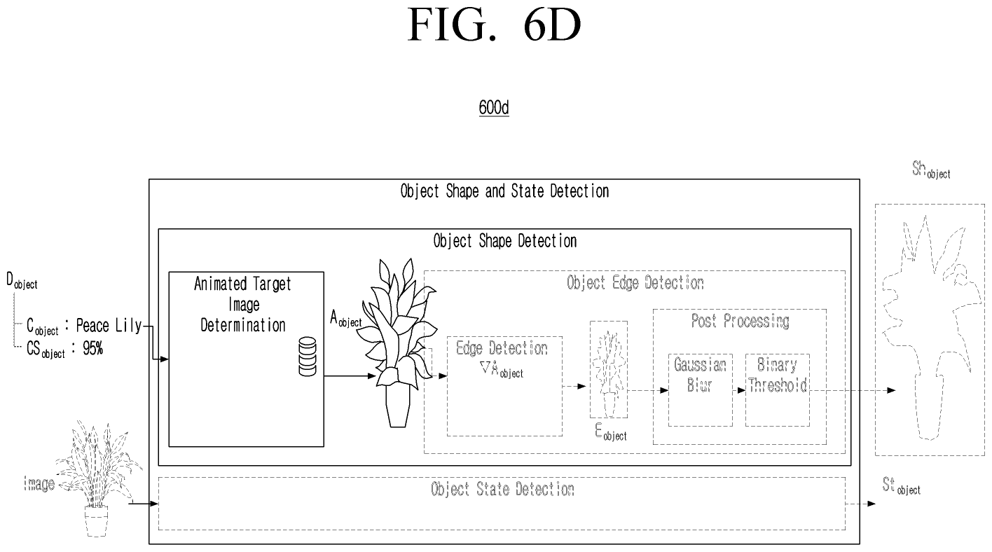

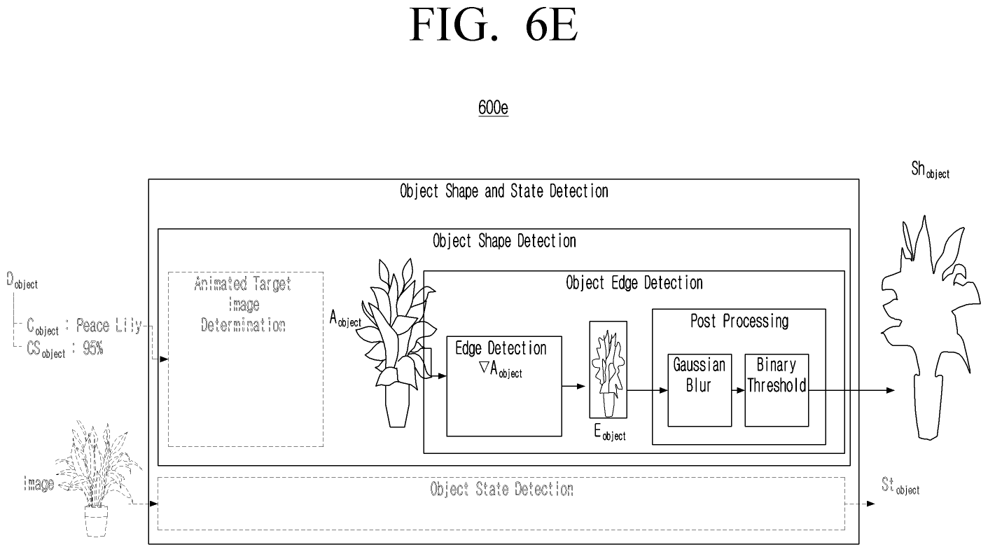

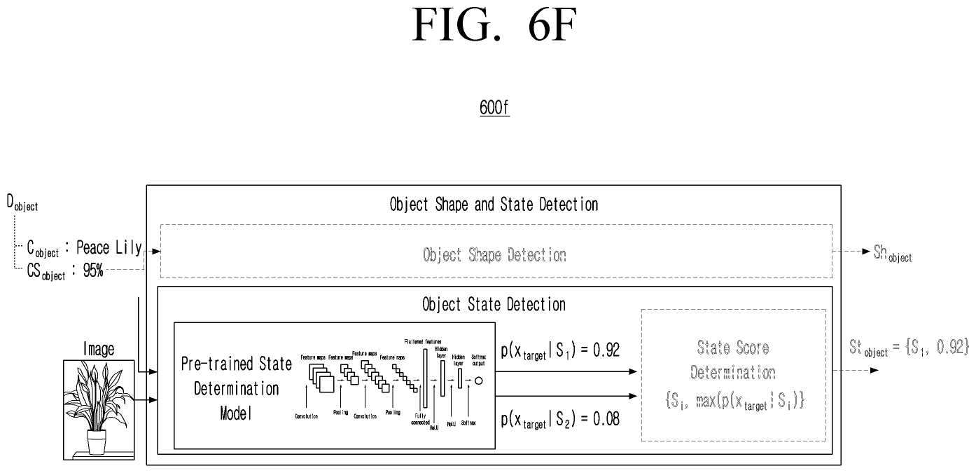

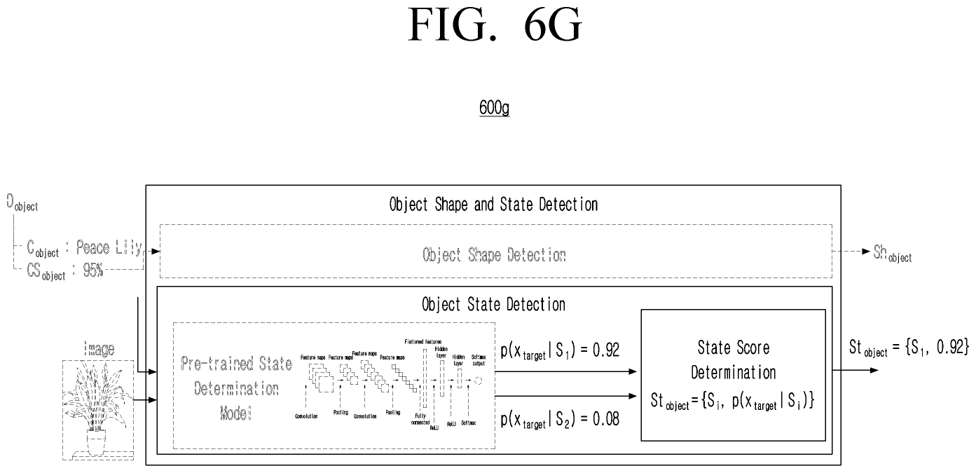

FIG. 6A is an operational flow diagram illustrating an example process 600a for an object shape and state detection, according to various embodiments. A shape and a state may be detected of an object detected from an input. The input may be one of an image and a video. Further, the object shape and state detection may be performed for generating an imaginary avatar for the object. The object shape detection may be performed by the shape determining unit 218 as referred in FIG. 2, and the object state detection may be performed by the state determining unit 220 as referred in FIG. 2. The object shape and state detection may include receiving object details, D_{OBJECT} associated with the object. The object details may also be referred as at least one object detail as referred in FIG. 1 and FIG. 2. Further, based on the input, the Shape of the object, Sh_{object} and a state score of the object St_{object} may be generated as an output.

The object shape and state detection may determine the shape and the state score of the target object. Thus, the object shape and state detection contain major steps such as the object shape detection and the object state detection. The object shape detection may determine the shape of the object. The object shape detection includes an animated target image determination and an object edge detection.

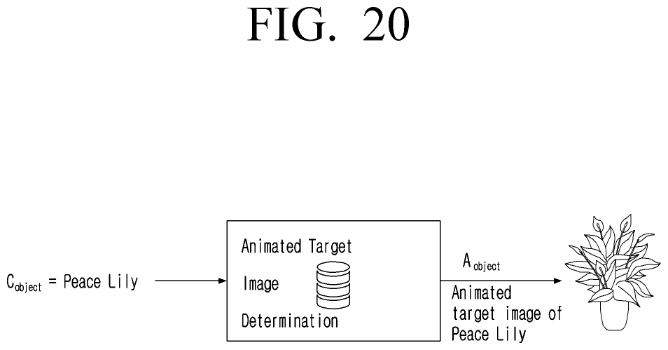

The animated target image determination may include obtaining animated image of the target object, A_{object}, for the input object details D_{object} containing information about a class of the target object, C_{object}. The animated image maybe a 2D image or a 3D image depending upon a database. As an example, for the input C_{object}=peace lily, the output is as shown in FIG. 20.

The object edge detection may include applying basic edge detection techniques to detect shape of the imaginary avatar for the animated target image A_{object} For a 3D imaginary avatar, the image of a front view may be processed.

Examples of the edge detection techniques that may be used for detection of edge of the animated target image may include Sobel Edge Detector, Prewitt Edge Detector may be used to determine the edge of objects as follows:

$${E}_{object} = ∇ {A}_{object} = \vert {A}_{object , x} \vert + \vert ∇ {A}_{object , y} \vert = \vert {A}_{object} ⊙ {G}_{x} \vert + \vert {A}_{object} ⊙ {G}_{y} \vert \qquad ( 1 )$$

where, E_{object} is the gradient of the input Animated Target Image A_{object}, ∇A_{object,x} and ∇A_{object,y} are the gradient of A_{object} in x and y axes, Gₓ and G_{y} are the traditional 3×3 Sobel kernels defined as follows:

$${G}_{x} = \begin{matrix}- 1 & - 2 & - 1 \\ 0 & 0 & 0 \\ 1 & 2 & 1\end{matrix} \\ {G}_{y} = \begin{matrix}- 1 & 0 & 1 \\ - 2 & 0 & 2 \\ - 1 & 0 & 1\end{matrix}$$

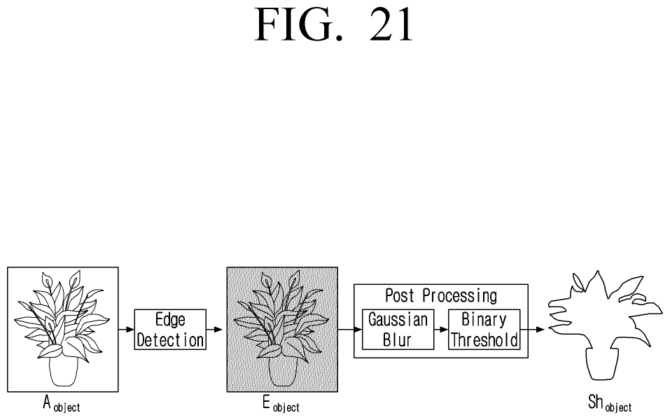

For post processing, a Gaussian Blurring followed by a binary threshold based on pixel values of the E_{object} (output of Edge detector) may further remove the non-significant edges, to output Shape of object, Sh_{object}. An example output for the Animated Target Image for Peace Lily is as shown in FIG. 21.

Further, the object state detection may determine the state or the condition of the object. The object state detection may include a state determination model training and a state score determination.

It is important to train a CNN model for a target object classification into two classes—S₁, S₂, of a good state or a bad state respectively. A good state, S₁ is defined as the ideal condition of the appearance of the object. A bad state, S₂ is defined as the non-ideal condition of the appearance of the object. To achieve this goal, it is required to pre-process the dataset of images used in object classification. A pre-processing dataset includes categorizing the dataset into two classes of a good and a bad state. This is done using human feedback or hand labeling the dataset. So, for a given image from dataset, xₜᵣₐᵢₙ and given output class corresponding to xₜᵣₐᵢₙ as Sᵢ, 1≤i≤2, a CNN model is trained.

With a pre-trained model to classify the target object into either of a good or a bad category, Object's state score, St_{object}, is calculated as follows:

$${St}_{object} = \{ {S}_{i} , p ( {x}_{target} \vert {S}_{i} ) \} \qquad ( 2 )$$

where, Sᵢ is such that p(x_{target}|Sᵢ) is maximized. ∀1≤i≤2
where, x_{target} is the input target object image,
Sᵢ are the states of object, e.g., a good or a bad state,
p(x_{target}|Sᵢ) is the probability of input target image belonging to state Sᵢ

Object's state score is, thus, a maximum of the two probabilities of the object belonging to either of the two classes of the model S₁ and S₂. An exemplary instance includes—A peace lily plant having green leaves is classified to a good state. But one having yellow or black leaves is considered as a bad state of the target object. Other instances include broken pen, torn book as bad state.

FIG. 6B is a diagram 600b illustrating an example of the state determination model, according to various embodiments. The architecture diagram 600b may be suitable for classification of the input image to one of the two classes is as shown in the architectural diagram 600b.

FIG. 6C is a diagram 600c illustrating an example architecture of the state determination, according to various embodiments. The state determination may be performed using a CNN model. The diagram 600c may be used to determine the state score.

FIG. 6D is a diagram 600d illustrating example generation of the animated image of the target image in the object shape detection, according to various embodiments. The object details may be received, and the animated image of the target object may be generated as an output.

FIG. 6E is a diagram 600e illustrating example object edge detection in the object shape detection, according to various embodiments. The animated image of the target object may be received as an input and the shape may be determined.

FIG. 6F is a diagram 600f illustrating an example pre-trained state determination model used in the object state detection, according to various embodiments. The state may be determined based on the object details such as the detected target object and the confidence score associated with the target object.

FIG. 6G is a diagram 600g illustrating example state score determination in the object state detection, according to various embodiments. The state score may be determined based on the state of the target shape.

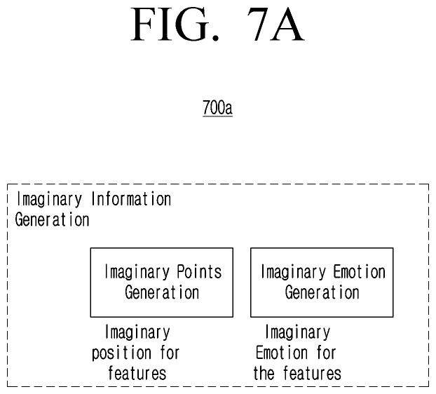

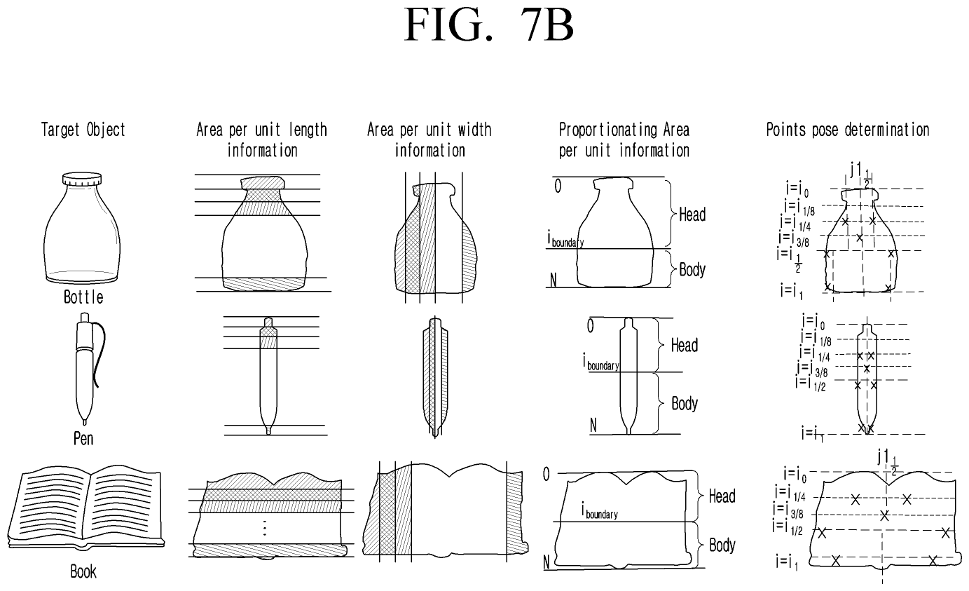

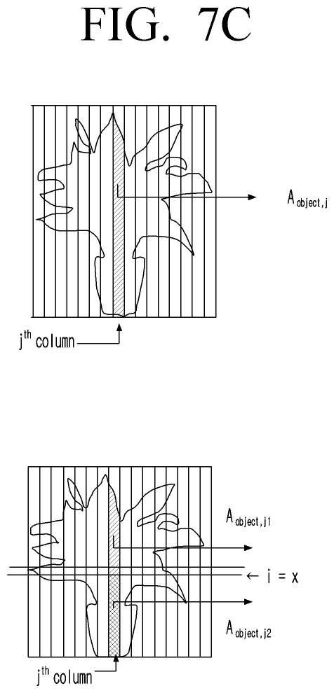

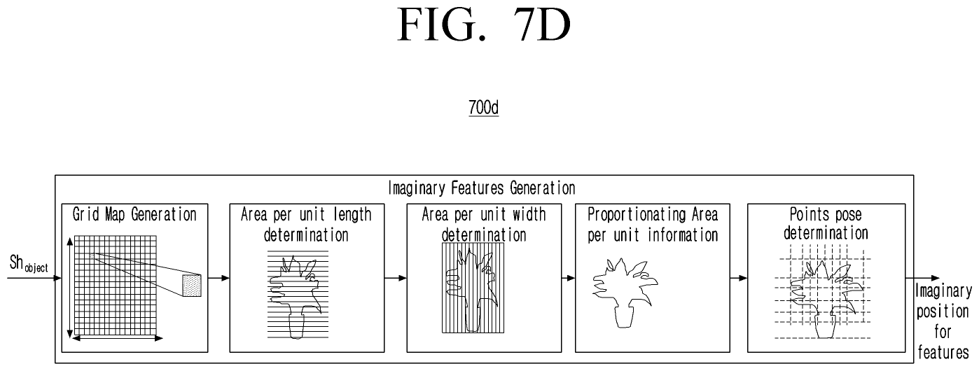

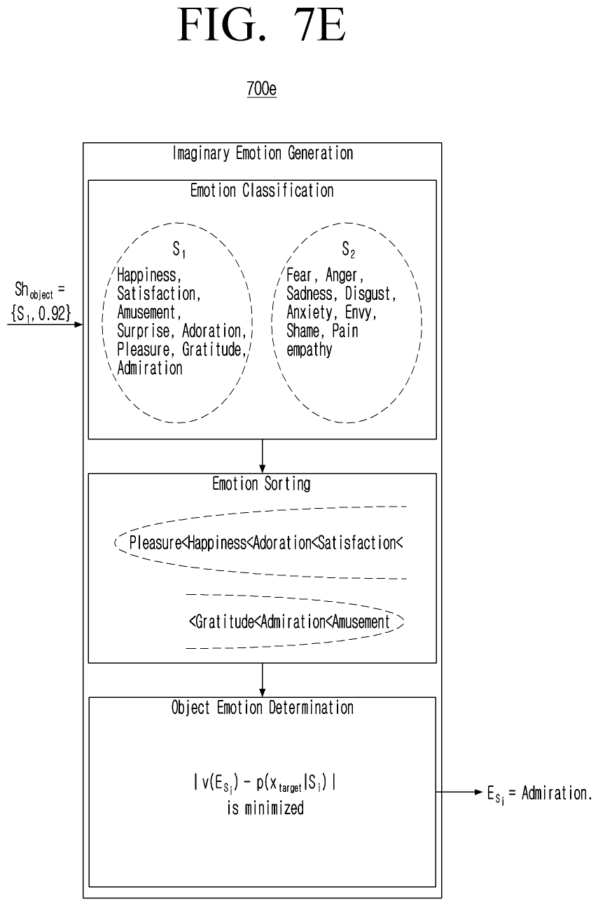

FIG. 7A is an operational flow diagram illustrating an example process 700a for an imaginary information generation, according to various embodiments. The imaginary information generation may be performed in order to generate an imaginary avatar of a target object detected in an input. The input may be one of an image and a video. The imaginary information generation may be performed by the position determining unit 222 and emotion determining unit 224 as referred in FIG. 2. The process 700a may include receiving an object's shape, Sh_{object} and the object's state score St_{object} as an input and providing an imaginary position for features, and an imaginary-emotions for features of the target object. An aim of the imaginary information generation may be generating imaginary information for an animated target object, A_{object}. The imaginary information includes generation of the imaginary position for the features and the imaginary emotions for the features. Significance of generating imaginary information are as follows:

The Features give an imaginary look to the animated target object. Imaginary Features include features such as eyes, nose, mouth, hair, ears, hands, legs, belly button, etc. The term “imaginary” is used as the features as stated above, need not exist in the real world object. As an example, plant, book, pen, etc. don't have any of the above stated features in reality. Thus, a position determination for these stated Imaginary features over the shape of the target object is disclosed.

The imaginary emotion determines emotion that should be conveyed by the determined imaginary features. Imaginary emotion includes happy, sad, angry, satisfied, overwhelmed, depressed, etc. The state of the object, St_{object}, is used to determine the emotion for each of the imaginary feature's position. As an example, a healthy peace lily may show one of the happy, overwhelmed, satisfied or the like. expression but on the other hand a drying or a rotting plant will show one of the sad, angry, depressed, etc. expression. Thus, an emotion determination of these stated imaginary features using state of the object is disclosed.

The imaginary features generation receives the object's shape, Sh_{object} as an input and generates the imaginary position for features, Imₚₒₛₑ as an output. The target object maybe of arbitrary shape. The shape need not resemble human-like or animal-like shape. The imaginary features are determined for such objects. It should be noted that these imaginary features may be determined by position determining unit 222 of FIG. 2.

The imaginary features generation involves major sub-steps such as a grid map generation, an area per unit length determination, an area per unit width determination, proportionating area per unit information, and points pose determination.

The grid map generation includes generating a grid Map, G. The dimensions of G are same as that of Sh_{object}. Let the dimension of G be N×M. Grid Map is a map of grids, g, of size n×m over the N×M map, given n<N and m<M.

It must be noted that the number of grids, n(g) present in the Grid Map, G is as follows:

$$n ( g ) = \frac{NM}{n m}$$

The area of each grid A(g) will be considered as a unit area or a constant area.

A(g)=c where, c is positive constant.

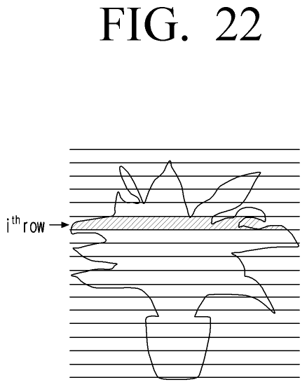

The area per unit length determination may include placing the input shape of object, Sh_{object} over the grid map. The area per unit length is defined as the area of the shape of object lying per unit length on the grid. Mathematically,

$${A}_{object , i} = n ( {g}_{object , i} ) \times A ( {g}_{object , i} ) ∀ 0 \leq i \leq N$$

where, A_{object,i} is area of the shape of object lying i^{th} row of grid map, n(g_{object,i}) represents the number of the grids lying within Sp_{object} in i^{th} row of G,A(g_{object,i}) represents the area of each grids. Exemplary depiction of A_{object,i} for the i^{th} row of G is as shown in FIG. 22.

A_{object,i} represents the area of the shape of the object lying in the i^{th} row of grid map.

The other term used for this is Area per unit length, e.g., Area per unit row.

The number of the grids lying within shape of object in i^{th} row of grid map, n(g_{object,i}) is determined as follows:

$$n ( {g}_{object , i} ) = {\sum }_{j} {r}_{j} - {l}_{j} + 1 , where , {r}_{j} \geq {l}_{j} ,$$

lⱼ is the column containing the next left edge, 0≤lⱼ<M
rⱼ is the column containing the right edge after the left edge, lⱼ, 0≤rⱼ<M

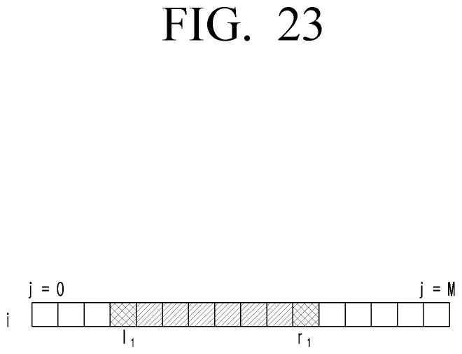

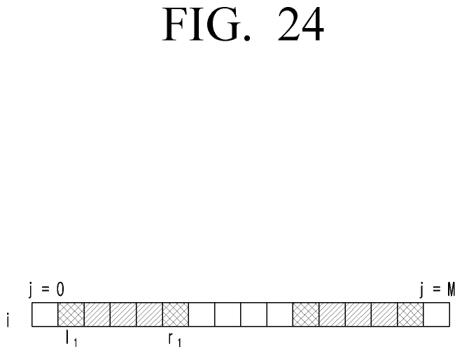

The determination of lⱼ and rⱼ maybe be done in numerous ways of image processing. One simple way is to pixelate the image and determine the Columns where the pixel value has edge. Exemplary depictions of two cases are in FIG. 23 and FIG. 24.
For the case shown in FIG. 23, n(g_{object,i})=r₁−l₁+1=7
For the case shown in FIG. 24, n(g_{object,i})=(r₁−l+1)+(r₂−l₂+1)=8

Once the determination of n(g_{object,i}) is done, Area per unit length or Area of shape of object lying per unit row maybe done as described:

A_{object,i}=n(g_{object,i})×c, where c is a positive constant.

The area per unit width determination includes performing steps required in the area per unit length determination. However, two area per unit width information are calculated for every column. The input shape of object, Sh_{object} is placed over the grid map. The area per unit width is defined as the area of the shape of object lying per unit width on the grid. Mathematically,

$${A}_{object , j} = n ( {g}_{object , j} ) \times A ( {g}_{object , j} ) ∀ 0 \leq j \leq M$$

where,
   A_{object,j} is area of the shape of object lying in j^{th} column of grid map,
   n(g_{object,i}) represents the number of the grids lying within Sp_{object} in j^{th} column
   A(g_{object,i}) represents the area of each grids.

A_{object,j} represent the total area lying inside the shape of object in column j. However, it can be written as sum of two areas, A_{object,j1} and A_{object,j2} as follows:

$${A}_{object , j} = {\sum }_{i = 0}^{x} {A}_{object , j , i} + {\sum }_{i = x}^{N} {A}_{object , j , i} = {A}_{object , j 1} + {A}_{object , j 2}$$

where,
A_{object,j1} represent the area of the shape of object lying in j^{th} column of grid map from row i=0 to x
A_{object,j2} represent the area of the shape of object lying in j^{th} column of grid map from row i=x to N

The x is typically determined by proportionating the Area per unit length information which is explained in proportionating area per unit information.

$$x = {i}_{1 / 2} ,$$

where x=i_{1/2} represents the row at which area above it and below it is halved.

Thus, the aim is to determine two area per unit length information, A_{object,j1} and A_{object,j2}. Accordingly the number of the grids lying within shape of object in j^{th} column of grid map is determined as follows:

$$n ( {g}_{object , j 1} ) = {\sum }_{i} b {1}_{i} - t {1}_{i} + 1 , where , b {1}_{i} \underline{>} t {1}_{i} , n ( {g}_{object , j 2} ) = {\sum }_{i} b {2}_{i} - t {2}_{i} + 1 , where , b {2}_{i} \underline{>} t {2}_{i} ,$$

where,
t1ᵢ is the row containing the next top edge, 0≤t1ᵢ<x
t2ᵢ is the row containing the next top edge, x≤t1ᵢ<N
b1ᵢ is the row containing the bottom edge after the top edge, t1ᵢ, 0≤b1ᵢ<x
b2ᵢ is the row containing the bottom edge after the top edge, t2ᵢ, x≤b2ᵢ<N

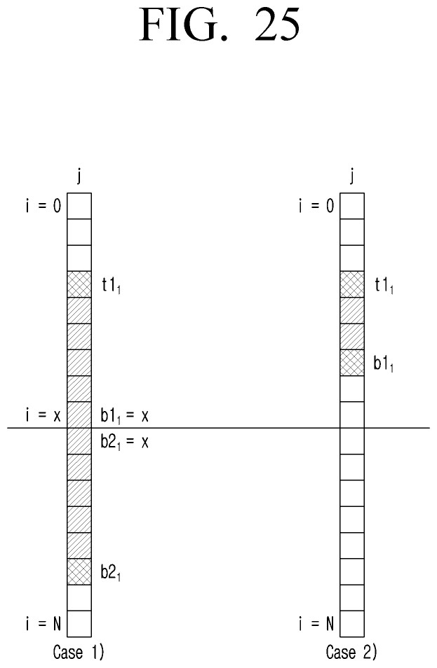

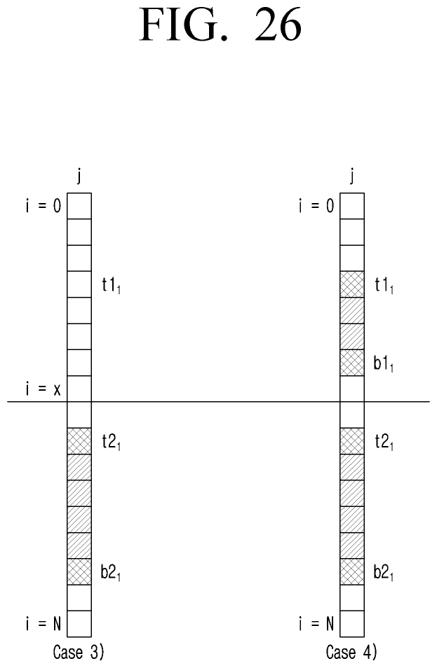

Various edge embodiments in FIG. 25 and FIG. 26, as shown needs proper handling in calculation of area:

case 1) t1ᵢ exist in range 0 to x but b1ᵢ doesn't exist. In such cases, for a closed object, t2ᵢ will also not exist in range x to N but b2ᵢ will exist.

Case 2) t1ᵢ and b1ᵢ exist in range 0 to x but t2ᵢ and b2ᵢ do not exist.

Case 3) t2ᵢ and b2ᵢ exist in range x to N but t1ᵢ and b1ᵢ do not exist.

Case 4) t1ⱼ, t2ⱼ, b1ⱼ and b2ⱼ all exist.

Thus, A_{object,j1} and A_{object,j2} is determined by calculating n(g_{object,j1}) and n(g_{object,j2}) The proportionating area per unit information includes determining the proportionated area per unit information based on the area per unit length, A_{object,i} and the area per unit width, A_{object,j1} and A_{object,j2} information, as shown in FIG. 7b. The proportionating area per unit information may be used later for Points pose determination. A generalized proportionating algorithm is as explained below:

Let 0≤i<N represent the row of the grid map and 0≤j<M represent the column of the grid map, then the aim is to determine proportionated row and column indices as follows:
iₚ ≙ row at which the proportion of total area above it and below it is p

$$\frac{Area above row {i}_{p}}{Area below row {i}_{p}} ∼ p ⇒ \frac{{\sum }_{i = 0}^{{i}_{p}} {A}_{object , i}}{{\sum }_{i = {i}_{p}}^{M} {A}_{object , i}} ∼ p e . g . ,$$

Similarly, two indices for column are determined as follows:
j1ₚ ≙ column at which the proportion of total area left to it and right to it is p

$$\frac{Area left of column j {1}_{p}}{Area right of column j {1}_{p}} ∼ p ⇒ \frac{{\sum }_{j = 0}^{j {1}_{p}} {A}_{object , j 1}}{{\sum }_{j = j {1}_{p}}^{M} {A}_{object , j 1}} ∼ p e . g . ,$$

j2ₚ ≙ column at which the proportion of total area left to it and right to it is p

$$\frac{Area left of column j {2}_{p}}{Area right of column j {2}_{p}} ∼ p ⇒ \frac{{\sum }_{j = 0}^{j {2}_{p}} {A}_{object , j 2}}{{\sum }_{j = j {2}_{p}}^{M} {A}_{object , j 2}} ∼ p e . g . ,$$

where, 0≤p≤1.

As an example, for p=½, the proportionated indices will represent the row and the column at which area as defined above is halved, e.g., i_{1/2} represents the row at which

$$\frac{{\sum }_{i = 0}^{{i}_{1 / 2}} {A}_{o b j e c t , i}}{{\sum }_{i = {i}_{1 / 2}}^{N} {A}_{o b j e c t , i}} ∼ \frac{1}{2} .$$

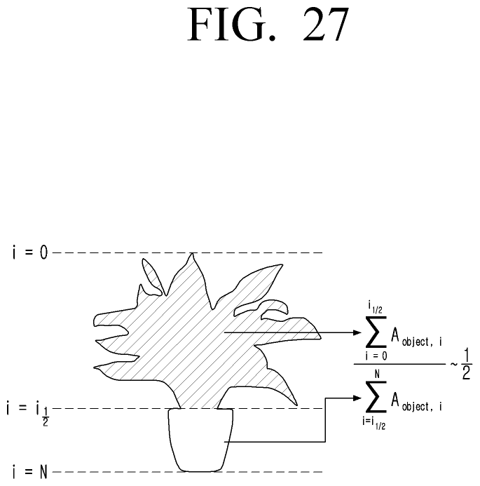

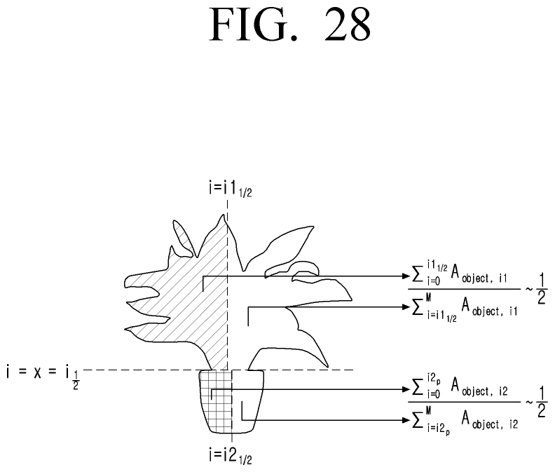

Example depiction is as shown in FIG. 27 and FIG. 28.

$$j {1}_{\frac{1}{2}} \& j {2}_{\frac{1}{2}}$$

represents the row at which

$$\frac{{\sum }_{j = 0}^{j {1}_{1 / 2}} {A}_{object , j 1}}{{\sum }_{j = j {1}_{1 / 2}}^{M} {A}_{object , j 1}} ∼ \frac{1}{2} \& \frac{{\sum }_{j = 0}^{j {2}_{p}} {A}_{object , j 2}}{{\sum }_{j = j {2}_{p}}^{M} {A}_{object , j 2}} ∼ \frac{1}{2}$$

respectively.

The points pose determination is based on points including position of features like: Hair, Eyebrows, Eyes, Nose, Mouth, Teeth, Tongue, Ears, Hands, Legs, etc. The target object may or may not have these features in real world appearance. The identified features above are classified into two broad categories of head and body. A Row Proportionate Index iₚ=i_{boundary} must be identified to separate the target object shape into head and body. Typical example includes

$${i}_{boundary} \geq \frac{1}{2} .$$

The logic behind defining

$${i}_{boundary} \geq \frac{1}{2}$$

is to make the target object head knowingly equal or bigger than their bodies. In animation, it is a commonly approached practice to make the animated object look more appealing and interesting to the user. However, any other i_{boundary} may be set as per requirement.

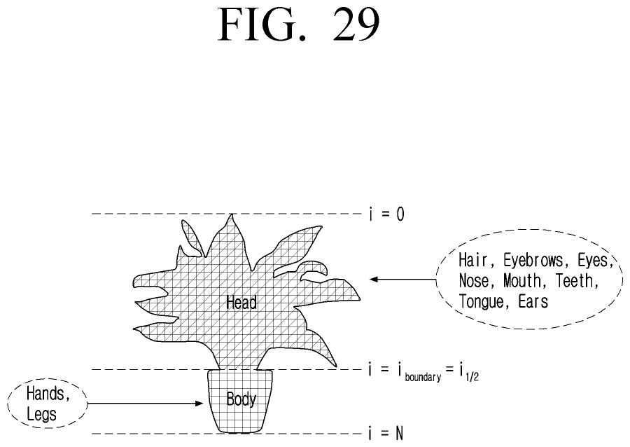

The aim is to now place the features in their respective categories of head and body as shown in FIG. 29. The position is determined using the proportionated indices as calculated earlier. For various points, the proportionated indices as tabulated below are calculated.

| | Row Proportionate | Column Proportionate |
|---|---|---|
| Points | Index iₚ | Index j1ₚ, j2ₚ |
| Eyes | i [symbol] | j1 [symbol] , j1 [symbol] |
| Nose | i [symbol] | j1_{1/2} |
| Mouth | i [symbol] | j1_{1/2} |
| Hands | i [symbol] | j2 [symbol] , j2 [symbol] |
| Legs | i [symbol] | j2 [symbol] , j2 [symbol] |

| | | | | | | |
|---|---|---|---|---|---|---|
| [symbol] Imₚₒₛₑ= | | i_{1/4} | j1_{3/8} | | | Imaginary (left) Eye pose |
| | | | | | → | |
| | | i_{1/4} | j1_{5/8} | | | Imaginary (right) Eye pose |
| | | | | | → | |
| | | i_{3/8} | j1_{1/2} | | | Imaginary mouth pose |
| | | | | | → | |
| | | i_{5/8} | j2 [symbol] | | | Imaginary (left) hand pose |
| | {open oversize bracket} | | | {close oversize bracket} | → | |
| | | i_{5/8} | j2_{7/8} | | | Imaginary (right) hand pos [symbol] |
| | | | | | → | |
| | | i [symbol] | j2 [symbol] | | | Imaginary (left) leg pose |
| | | | | | → | |
| | | i [symbol] | j2_{7/8} | | | Imaginary (right) leg pose |
| | | | | | → | |

[symbol]

indicates data missing or illegible when filed

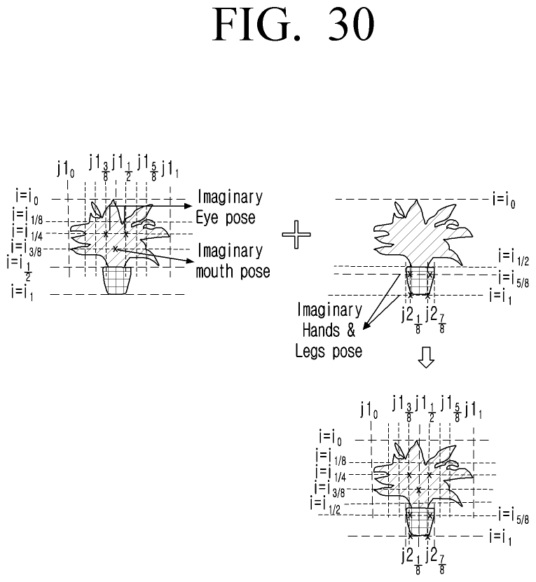

The above values shown are for illustrative purpose only. Further hits and trials are required to fine tune the values more. Exemplary Depiction of Eyes, Mouth, Hands and Legs are as shown in FIG. 30.

The disclosed pose determination is based on “proportionating area per unit information”. The area per unit information usage incorporates some information about shape of the object. The placement of features may be based on proportion of area contained in the object and not the height or width of object. Few more exemplary depictions are shown in FIG. 7B. The imaginary emotion generation may include receiving the object's state, St_{object} as an input and generating an imaginary emotion E_{S}_{ᵢ}. The imaginary emotion may be generated by the emotion determining unit 224 as referred in FIG. 2. The imaginary emotion generation may include an emotion classification, an emotion sorting, and an object emotion determination.

The emotion classification: The number of emotions is classified to belong to either of the two states S₁ or S₂. S₁ corresponds to good state. Thus, emotions belonging to “happy” category are classified to fall in S₁. This is done using pre-defined knowledge. Similarly, S₂ corresponds to bad state. Thus, emotions belonging to “sad” category are classified to fall in S₂. This is done using pre-defined knowledge.

The emotion sorting: The emotions belonging to either of the state S₁ or S₂ are sorted based on their extremeness.
S(E_{S}_{ᵢ}) ≙ Sorted list of Emotions belonging to state Sᵢ

The sorted list is formed based on v(Eₛ_{ᵢ}), e.g., value of Emotions belonging to state Sᵢ. Value is a measure of extremeness and is hand-scored or taken from a pre-defined database.

The object emotion determination: Object's state contains information as follows:

$${St}_{object} = \{ {S}_{i} , p ( {x}_{target} \vert {S}_{i} ) \}$$

e.g., a) the information about the State of the object S₁ or S₂ (good or bad state)
b) the State score of the object: p(x_{target}|Sᵢ)

Based on the state of the object, the corresponding Sorted Emotion list S(E_{S}_{ᵢ}) is determined. Choose, Emotion E_{S}_{ᵢ} from the list such that |v(Eₛ_{ᵢ})−p(x_{target}|Sᵢ)| is minimized. The logical meaning of minimizing/reducing the difference of Emotions value and the probability value is to determine a closest emotion from the list corresponding to the probability of object lying in good or bad state. As an example case, a healthy Peace Lily belonging to a very good state with state score p(x_{target}|Sᵢ)=0.92, may be assigned an emotion of higher value such as E_{S}_{ᵢ}=Admiration.

FIG. 7B is a diagram 700b illustrating an example process for imaginary features generation, according to various embodiments. The process may include the grid map generation, the area per unit length determination, the area per unit width determination, the proportioning area per unit determination, and the points pose determination.

FIG. 7C is a diagram 700c illustrating an example process for imaginary emotion generation, according to various embodiments. The process may include the emotion classification, the emotion sorting, and the object emotion determination.

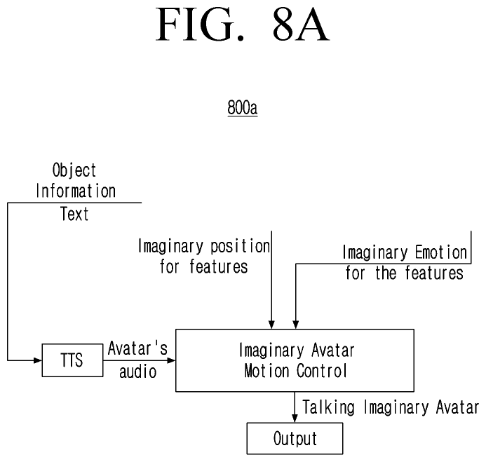

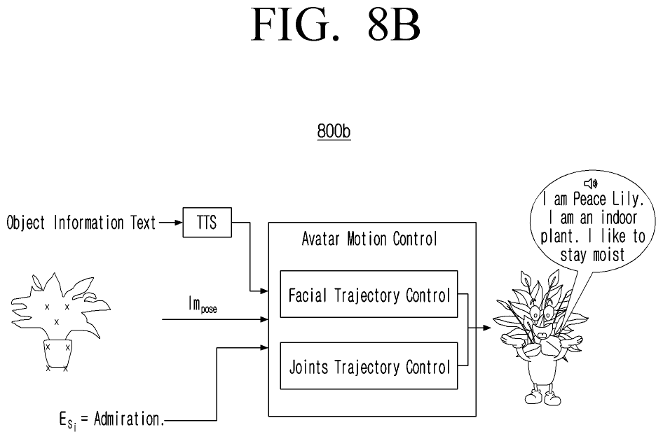

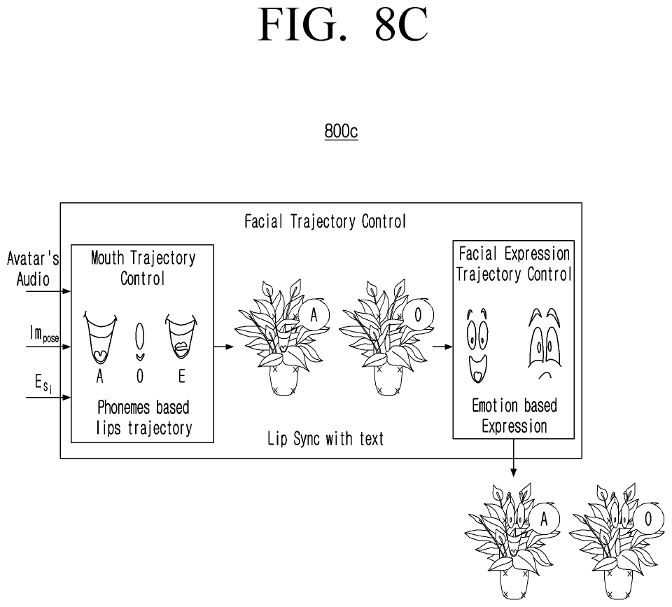

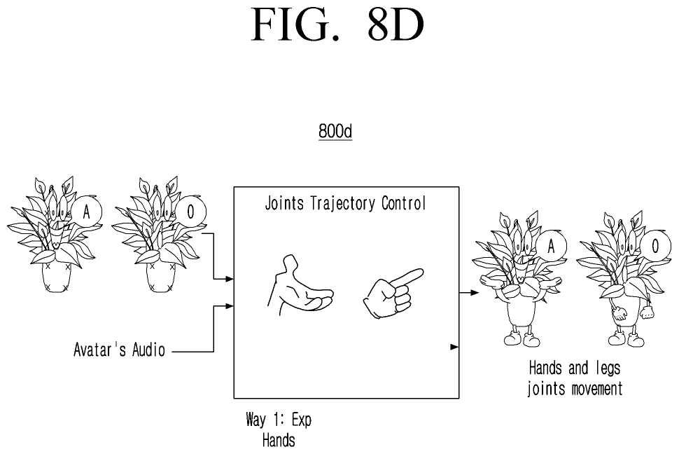

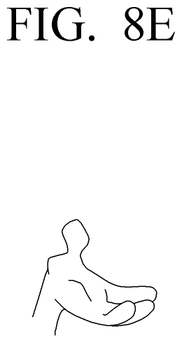

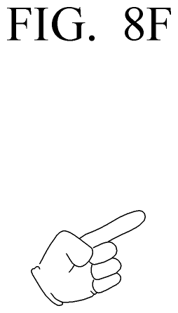

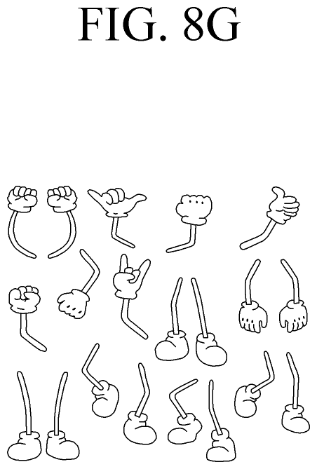

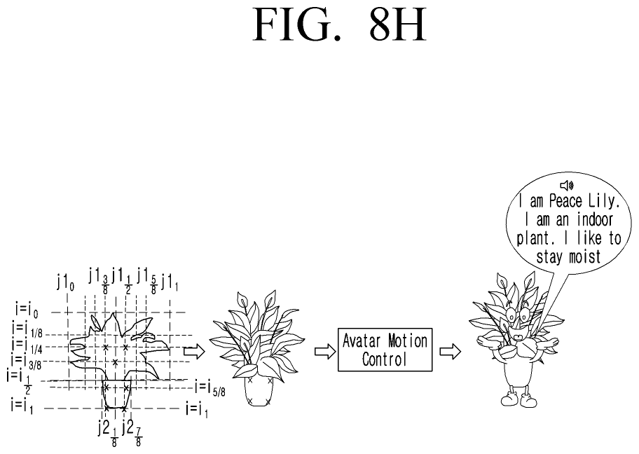

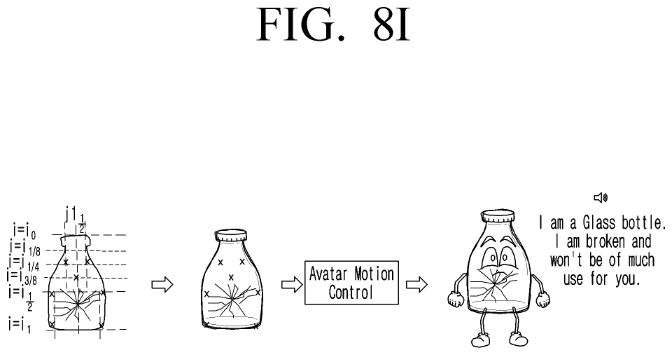

FIG. 8A is an operational flow diagram illustrating an example process 800a for an avatar motion controller, according to various embodiments. The process 800a may be performed by the generating unit 226 and the motion controller 228 as referred in FIG. 2. The process 800a may include receiving an avatar's audio, an imaginary position of features Imₚₒₛₑ, an imaginary emotion as an input and generating an imaginary avatar as an output based on the shape of the object, position of the plurality of physical features, and the determined emotion, by the generating unit 226. The Object information text, generated by the Object Information text formation step, is passed through a Text to Speech (TTS) block.

The Avatar motion control includes a facial trajectory control, and a joints trajectory control. In an embodiment, the avatar motion control of the generated imaginary avatar may be performed by the motion controller 228 as follow:

The facial trajectory control is to majorly control two important trajectories—mouth or the lip sync trajectories and emotion or the facial expression trajectories. The joints trajectory control is to majorly control the joints of the imaginary avatar. The joints include joints of imaginary hands and legs which are movable, in accordance with the human joints motion.

The facial trajectory control includes a mouth trajectory control, and a facial expression trajectory control.

The mouth trajectory control: The input avatar's audio is used to animate the avatar by making the lip-sync with respect to the avatar's audio. There are several states of art techniques available to perform lip-sync of the avatar. Phonemes information in the audio may be utilized to control the lips in synchrony with the audio play back. A CNN model was used for the same.

The facial expression trajectory control: The facial expressions trajectory control of the imaginary avatar includes trajectory control of imaginary points like eyes, eyebrows, nose, mouth, or the like. For an input Imaginary Emotion E_{S}_{ᵢ} a Character multi-layer perceptron was trained to give expression to the avatar.

The joints trajectory control: The joints of the Imaginary avatar maybe controlled. It must be noted that although the avatar is imaginary, but it has features like hands and legs at the determined Imaginary points. Thus, the trajectory of these imaginary hands and legs must follow the kinematics of human joints movement, in spite of them being imaginary. A state of art method is followed to make the joints move in accordance with the type of text. As an instance, if the Object information text has “information” that the target object is explaining to the user, then the imaginary hands may bend in way 1 in order to explain, as shown in FIG. 8E. Other cases could be—if target object is complaining to the user, then the imaginary hands may bend in way 2 in order to complaint, as shown in FIG. 8F. FIG. 8G illustrates various ways of joints movement, according to various embodiments.

Based on the target object's imaginary points pose and imaginary information generation, avatar motion control as explained is in accordance with one use case of—“avatar's communicating to the user”. The animation of avatar by making its lips move, or facial expression changes and joints motion is an existing state of art method specially in the field of gaming, as explained in previous section. The features that must be placed at the imaginary points pose maybe determined manually by user.

FIG. 8B is a diagram 800b illustrating example avatar motion control, according to various embodiments. The object information such as avatar's audio, an imaginary position of features, an imaginary emotion and the object emotion may be used as the input so as to control the moment of the avatar.

FIG. 8C is a diagram 800c illustrating example facial trajectory control, according to various embodiments. The imaginary position of features, the audio, and the emotion may be used as an input for the facial trajectory control.

FIG. 8D is a diagram 800d illustrating example joints trajectory control, according to various embodiments. The audio of the avatar may be used as an input for the joint's trajectory control.

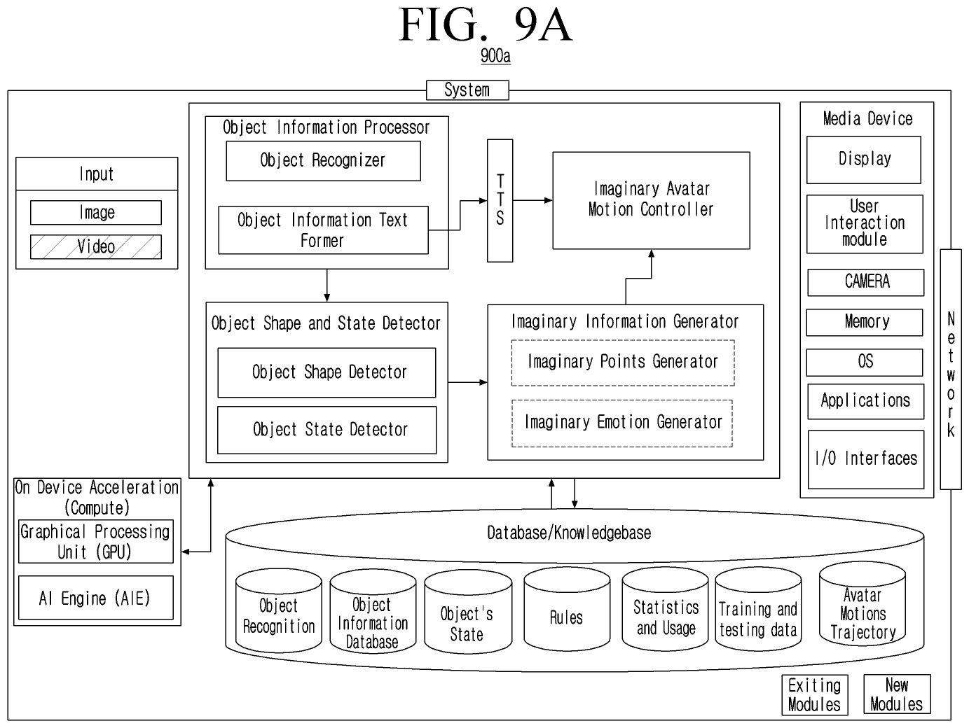

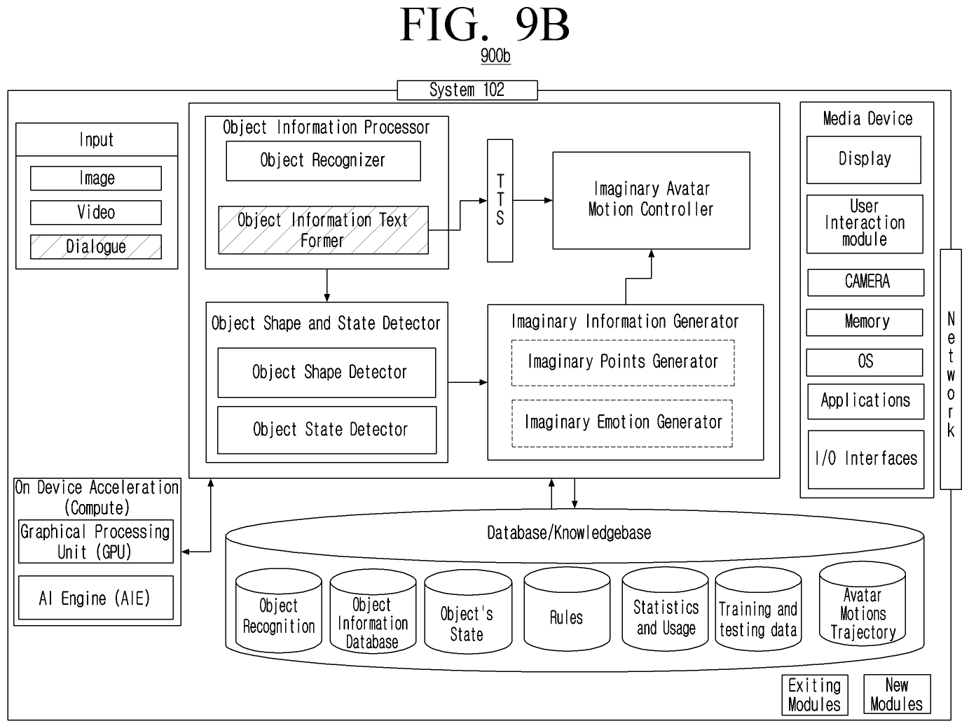

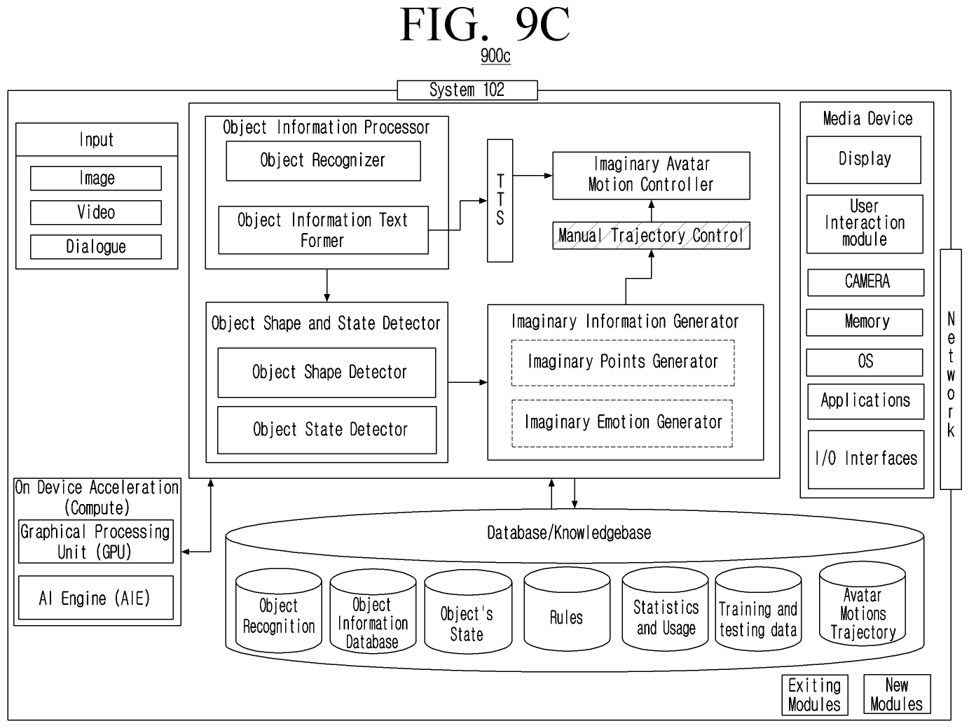

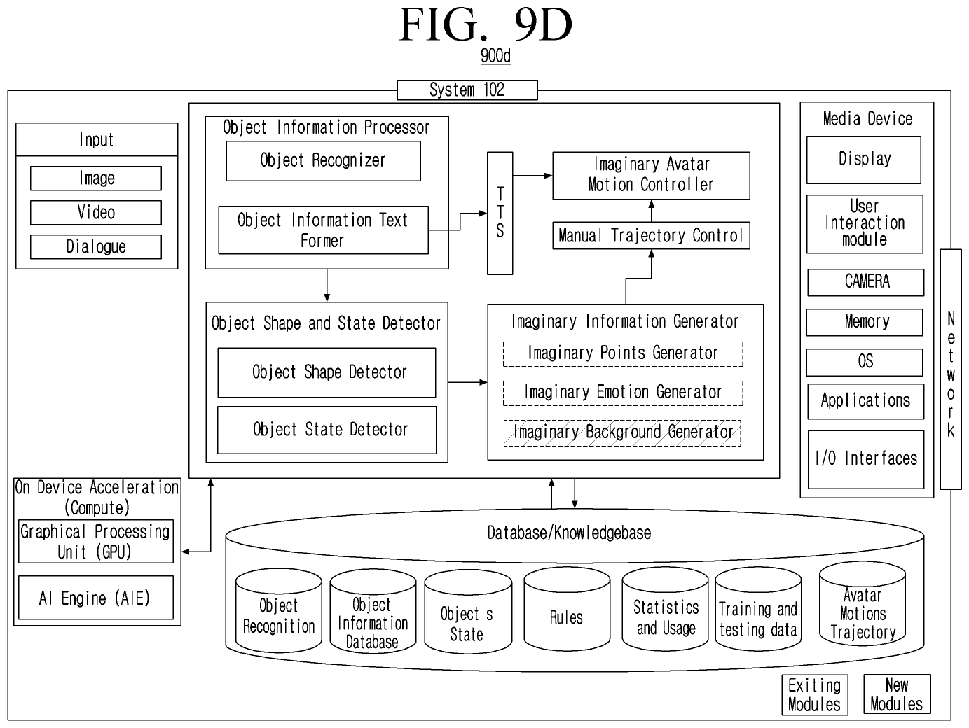

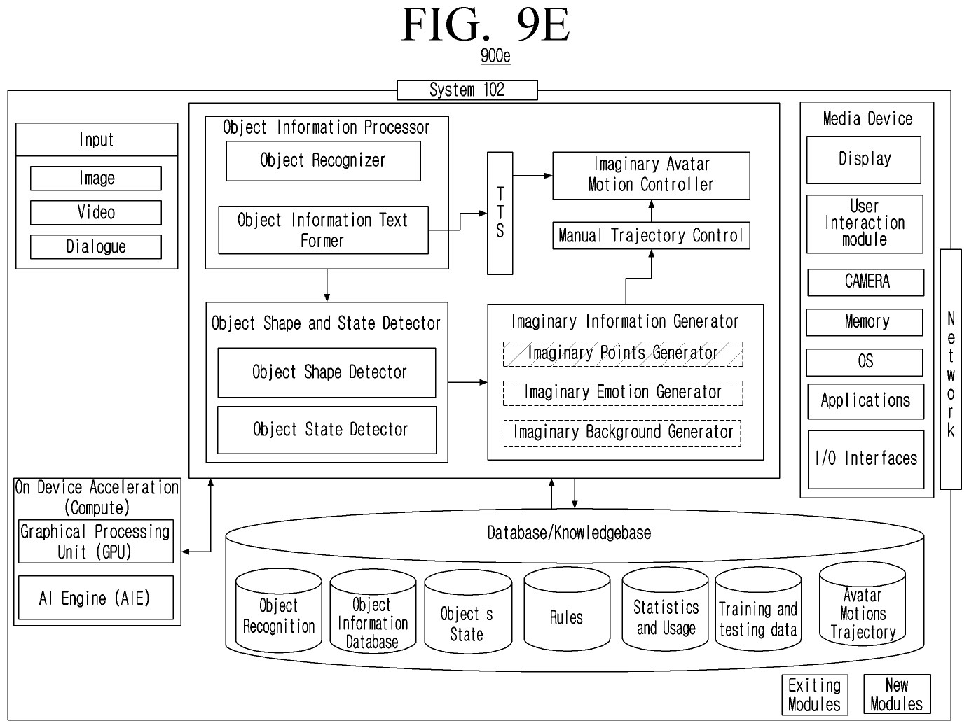

FIG. 9A is a diagram 900a illustrating an example method for generating an imaginary avatar, according to various embodiments. The architectural diagram 900a may be an embodiment of the architectural diagram 400 as referred in FIG. 4. An input type maybe a video as well. The same method may apply for a particular frame of the video in similar way.

FIG. 9B is an architectural diagram 900b illustrating an example method for generating an imaginary avatar, according to various embodiments. The architectural diagram 900b may be an embodiment of the architectural diagram 400 as referred in FIG. 4. An object information text former may obtain object information text not only from a database, but also from a user's input. As an instance, a user may want the imaginary avatar to speak some dialogues, that may or may not be related to the object's description.

FIG. 9C is an architectural diagram 900c illustrating an example method for generating an imaginary avatar, according to various embodiments. The architectural diagram 900c may be an embodiment of the architectural diagram 400 as referred in FIG. 4. There may be an additional manual trajectory control step, using which user can design custom actions of the imaginary avatar. As an instance, user can give manual input indicating avatar to raise a hand, or to widen the legs or to frown. Avatar motion control can then realize the trajectories by changing facial expressions or by bending appropriate joints.

FIG. 9D is an architectural diagram 900d illustrating an example method for generating an imaginary avatar, according to various embodiments. The architectural diagram 900d may be an embodiment of the architectural diagram 400 as referred in FIG. 4. An imaginary background of the avatar may be formed additionally. The imaginary background generation may take background of the object from a predefined set of spaces or as a user input.

FIG. 9E is an architectural diagram 900e illustrating an example method for generating an imaginary avatar, according to various embodiments. The architectural diagram 900e may be an embodiment of the architectural diagram 400 as referred in FIG. 4. Imaginary points generator may use volume per unit information for a 3D animated target object. substantially the same method applies, only difference being that the grid G will now be a 3d grid N×M×L. Where L would be depending on the 3d object dimensions. N and M are as defined in 1st embodiment.

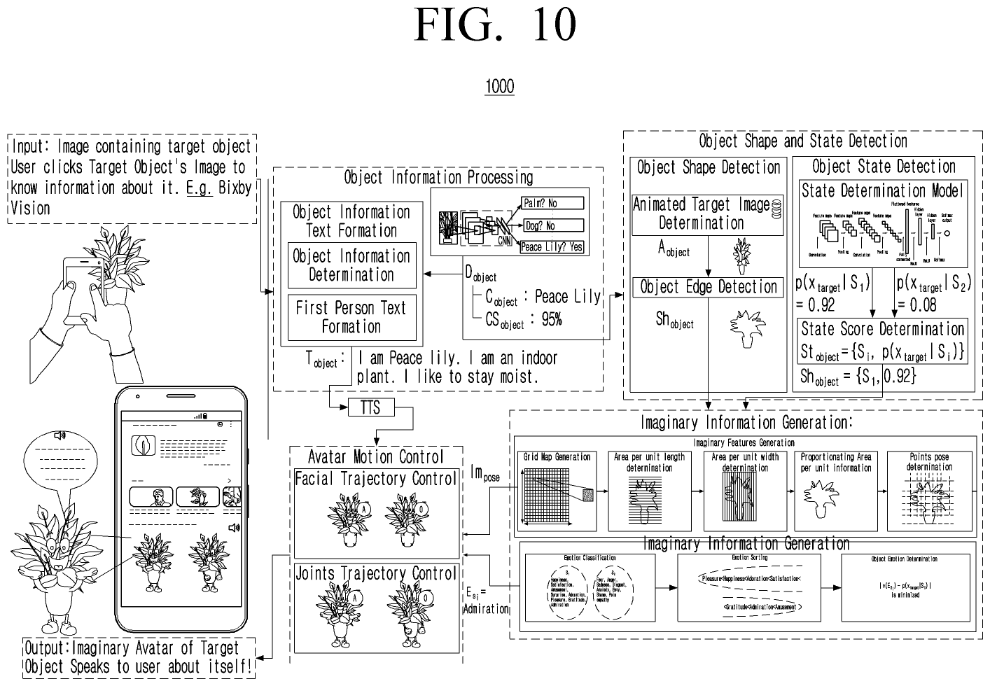

FIG. 10 is a use case diagram 1000 illustrating an example scenario for generating an imaginary avatar for an object, according to various embodiments. Initially, an object information processing is performed to determine details related to the object. Further, a shape and a state of the object is determined. Further, an imaginary feature generation is performed to determine position of features and an emotion of the object. Based on that, an avatar motion control is performed, and the imaginary avatar is generated as an output, as shown in FIGS. 8H and 8I. For example, as shown in FIG. 8I, a cracked bottle is in bad state so a sad expression is determined.

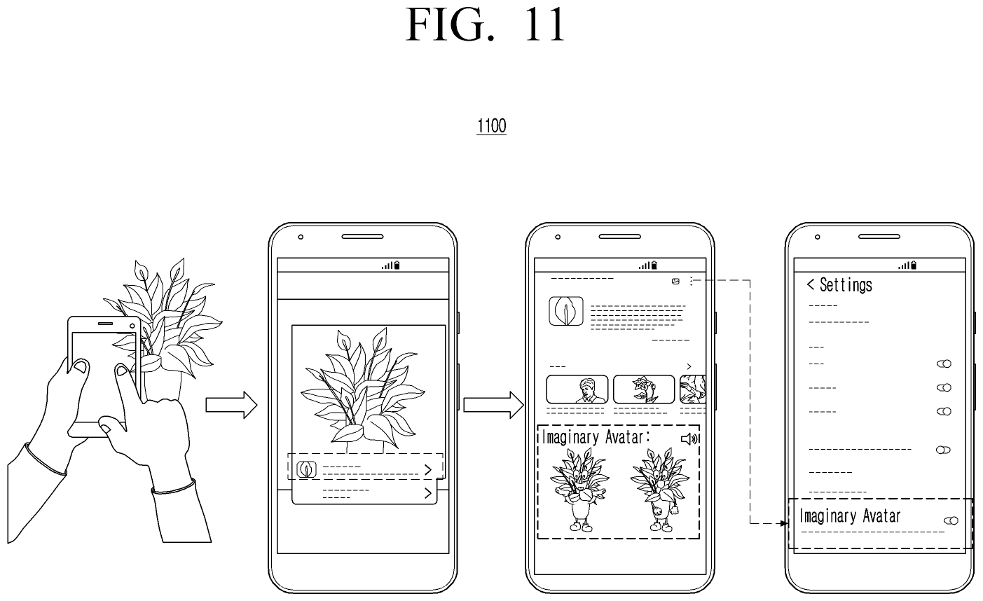

FIG. 11 is a use case diagram 1100 illustrating example generation of an imaginary avatar in a meta verse, in accordance with an embodiment of the present disclosure. User clicks target object's image to know information about it. The target object is processed, and object class is a peace lily/spathiphyllum confidence score is 95%, and object information text: information is determined. Apart from the conventional textual information, an imaginary avatar telling about itself is presented to the user. Imaginary Avatar can be provided as a configurable feature in Settings. User can turn it on or off based on the requirement.

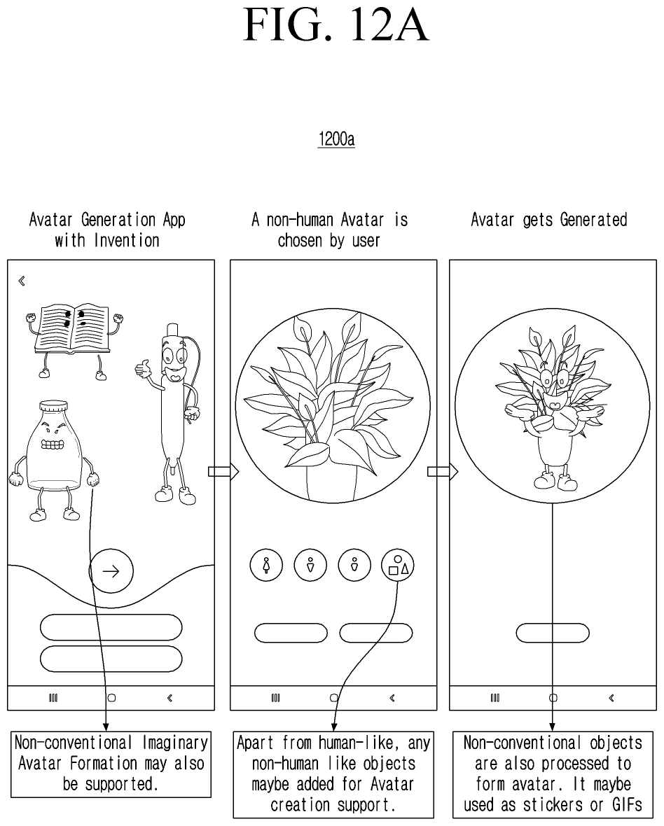

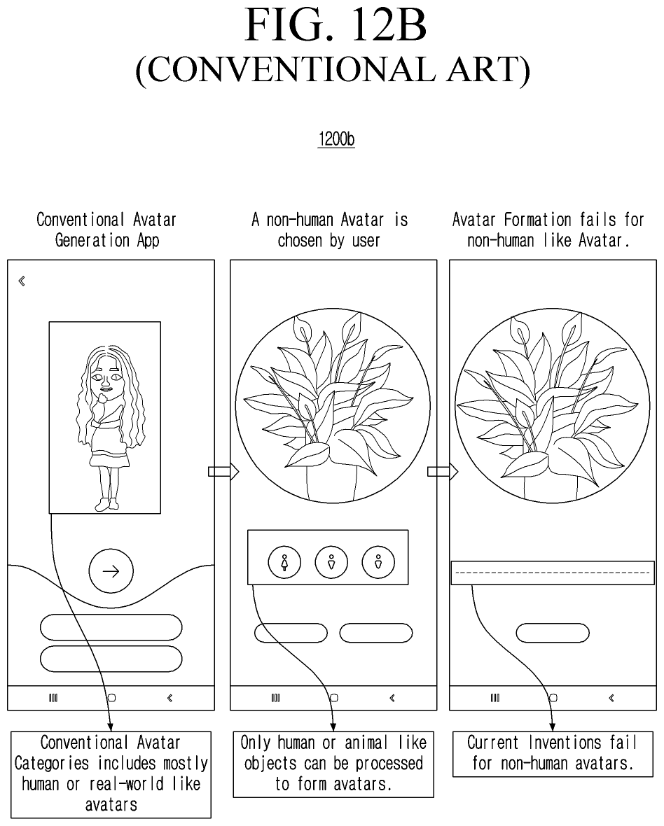

FIG. 12A is a diagram 1200a illustrating example imaginary avatar generation, according to various embodiments. Non-conventional Imaginary Avatar Formation may also be supported. Apart from human-like, any non-human like objects maybe added for Avatar creation support. Non-conventional objects are also processed to form avatar. It may be used as stickers or GIFs

FIG. 12B a use case diagram 1200b illustrating example imaginary avatar generation, according to the prior art. Conventional avatar categories include mostly human or real-world like avatars. Only human or animal like objects can be processed to form avatars. Current solutions fail for non-human avatars.

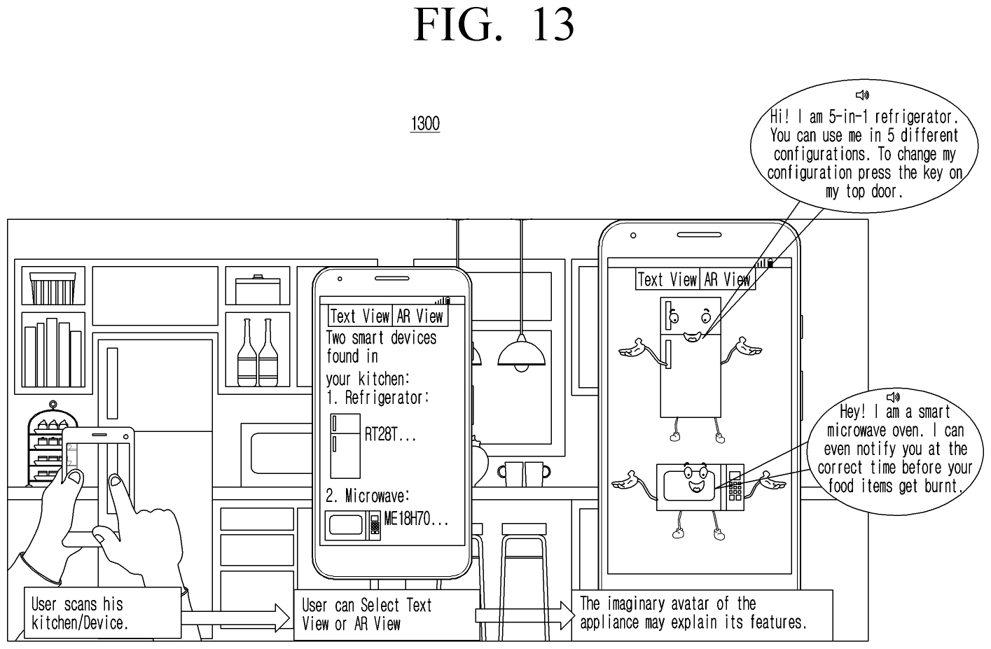

FIG. 13 is a use case diagram 1300 illustrating an example smarter home, according to various embodiments. User scans his kitchen/Device. User can Select Text View or AR View. The imaginary avatar of the appliance may explain its features.

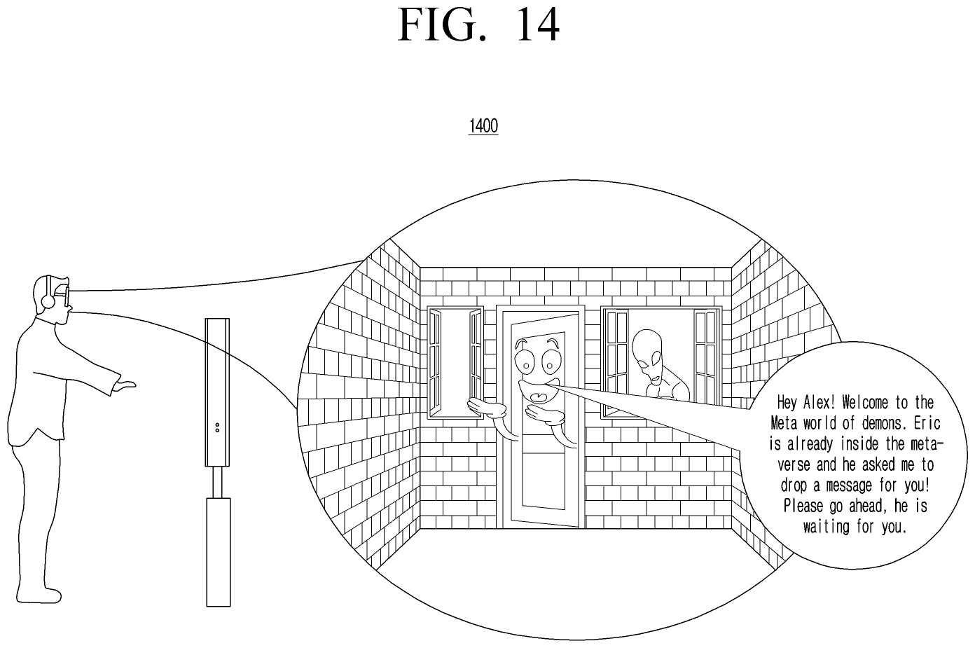

FIG. 14 is a use case diagram 1400 illustrating an example metaverse with more imagination, according to various embodiments. Entities of metaverse or VR which are non-human like can also be utilized as Avatars for interaction with users entering the metaverse. The objects existing in metaverse other than humans or animals, can also be used to guide, notify user about specific events or actions. In an embodiment of the present disclosure, The Avatar rendering may be done on a 2D interface or via VR glasses as well.

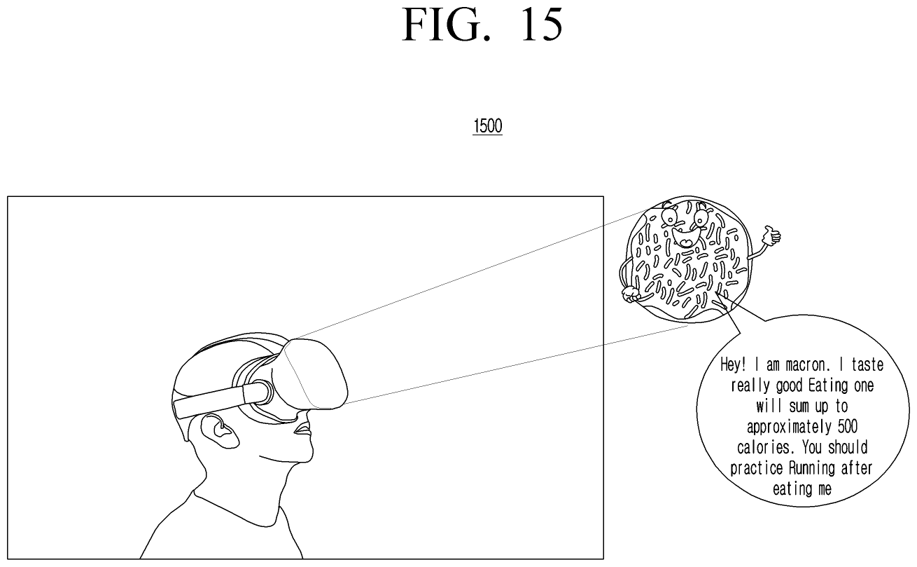

FIG. 15 is a use case diagram 1500 illustrating an example smart food guide, according to various embodiments. Food guide may tell the user information about the food calories and the amount of workout they must do in order to burn the calories. The information may be shared via an interactive imaginary avatar which will make the

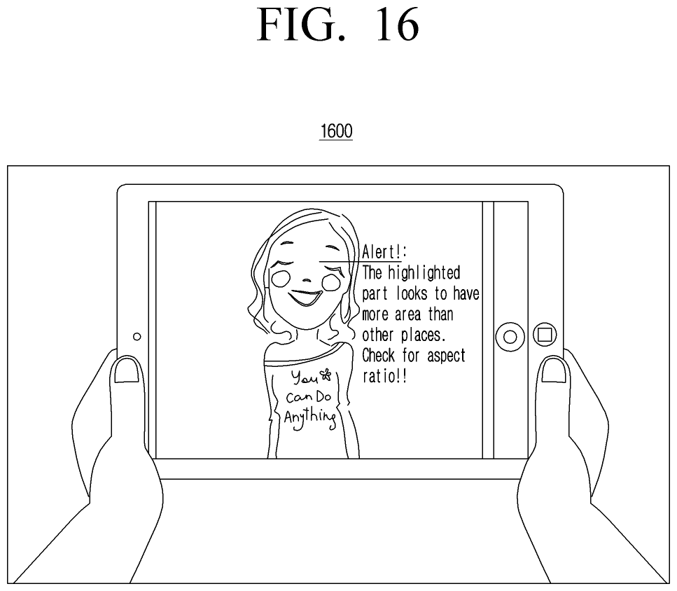

FIG. 16 is a use case diagram 1600 illustrating an example aspect ratio guide, according to various embodiments. Area per unit information of the drawing made on the tablet may be analyzed. A guide on aspect ratio correction may be provided to the user based on area per unit proportion of the drawing.

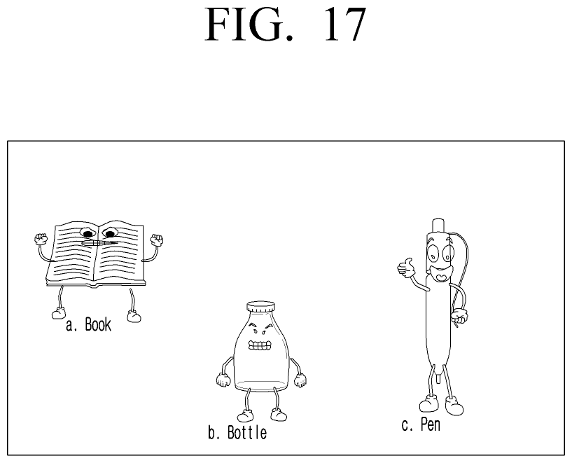

FIG. 17 is a diagram illustrating an example of imaginary avatar of objects, according to various embodiments. As shown in FIG. 17, a book, a bottle and a pen may be generated as imaginary avatar having human-like features such as mouth, eyes, hands, legs etc.

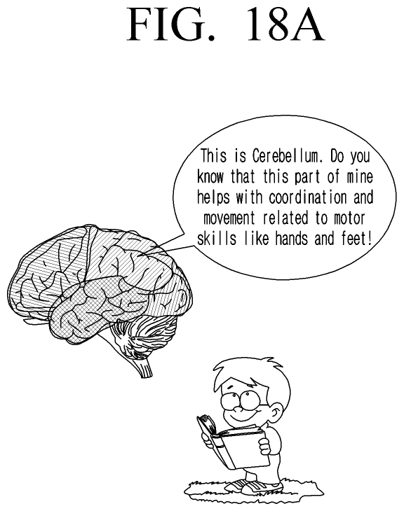

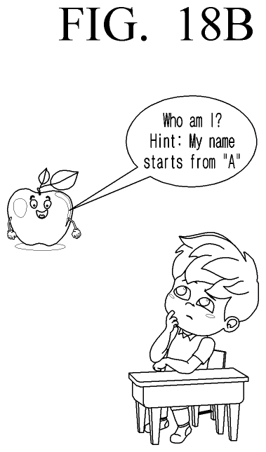

FIGS. 18A and 18B are diagrams illustrating example use case scenarios, according to various embodiments. As shown in FIG. 18A, education maybe made fun for children by adding imaginary avatars. It can make the subjects not only fun for them but also it will help them to remember the topics for longer duration. The Avatar rendering may be done on a 2D interface or via VR glasses as well. As shown in FIG. 18B, quiz and oral tests may be made more fun and interactive for students. The avatar may ask questions to the students. Its expression may change to sad, if the answer is wrong. And that to cheerful if answer is correct. The Avatar rendering may be done on a 2D interface or via VR glasses as well.

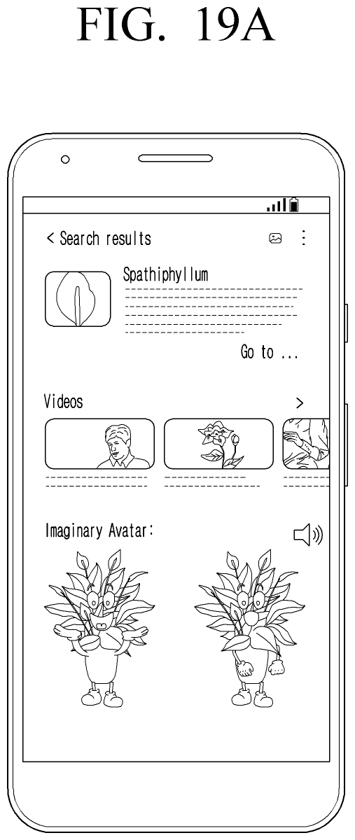

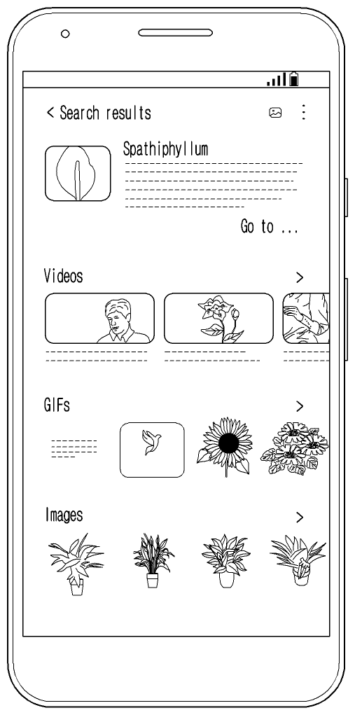

FIGS. 19A and 19b are diagrams illustrating a comparison between prior art and the present disclosure, according to various embodiments. FIG. 19A illustrates a result for a search query related to Peace Lily/Spathiphyllum, according to various embodiments. As shown in FIG. 19A, apart from the textual information, an imaginary avatar telling about itself is presented to the user. FIG. 19B illustrates result for a search query related to Peace Lily/Spathiphyllum, in accordance with prior art. As shown in FIG. 19B, textual Information is shown to the user. Related web pages and other information such as Videos GIFs is shown. There is no concept of Avatar based communication.

While specific language has been used to describe the disclosure, any limitations arising on account of the same are not intended. As would be apparent to a person in the art, various working modifications may be made to the method in order to implement the concept as taught herein. The drawings and the forgoing description give examples of various embodiments. Those skilled in the art will appreciate that one or more of the described elements may well be combined into a single functional element. Certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the disclosure or not, such as differences in structure, dimension, and use of material, are possible. The scope of embodiments is at least as broad as given by the following claims.

Benefits, other advantages, and solutions to problems have been described above with regard to various example embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A system for generating an imaginary avatar of an object, the system comprising:
at least one processor, comprising processing circuitry, configured to operate the system, including:
a detail determining unit comprising circuitry configured to determine at least one object detail from the object identified from an input content;
a shape determining unit comprising circuitry configured to determine a shape of the object based on the at least one object detail;
a state determining unit comprising circuitry configured to determine a state of the object based on the input content and the at least one object detail;
a position determining unit comprising circuitry configured to determine position of a plurality of physical features of the object based on the shape of the object;
an emotion determining unit comprising circuitry configured to determine an emotion depicted by the object using the state of the object; and
a generating unit comprising circuitry configured to generate the imaginary avatar of the object based on the shape of the object, position of the plurality of physical features, and the determined emotion.

2. The system as claimed in claim 1, wherein the detail determining unit is configured to determine textual information about the object using the at least one object detail; and
the generating unit is configured to:
convert the textual information into a speech; and
generate an audio for the imaginary avatar using the converted speech.

3. The system as claimed in claim 2, comprising:
a motion controller comprising circuitry configured to animate the imaginary avatar by controlling motion of the plurality of physical features of the imaginary avatar in sync with the generated audio.

4. The system as claimed in claim 1, wherein for determining the position of the plurality of physical features, position determining unit position determining unit is configured to:
derive an area per unit information of the object from the detected shape of the object;
segment the object in an upper part and a lower part based on the area per unit information; and
determine the position of the plurality of physical features in the upper and lower part of the object.

5. The system as claimed in claim 1, wherein the plurality of physical features includes at least two of eyes, ears, hair, lip, mouth, nose, hands and legs.

6. The system as claimed in claim 1, wherein the at least one object detail includes a class of the object and a confidence score of the object.

7. The system as claimed in claim 1, wherein for determining the shape of the object, the shape determining unit is configured to:
determine an animated image of the object;
determine edges of the object from the animated image of the object; and
determine the shape of the object based on the edges of the object.

8. The system as claimed in claim 1, wherein the shape determining unit is configured to determine the state of the object using a trained neural network model.

9. The system as claimed in claim 1, wherein the emotion determination unit is configured to determine the emotion from a group of specified emotions based on the state of the object.

10. The system as claimed in claim 1, wherein for generating the imaginary avatar of the object, the generating unit is configured to:
place the plurality of physical features based on determined position, on the shape of the object; and
impose the emotion on the plurality of physical features.

11. The system as claimed in claim 1, wherein for generating the imaginary avatar of the object, the generating unit is configured to:
determine background information of the object; and
generate the imaginary avatar of the object based on the background information.

12. The system as claimed in claim 1, wherein the input content is one of an image or a video.

13. A method for generating an imaginary avatar of an object, the method comprising:
determining at least one object detail from the object identified from an input content;
determining a shape of the object based on the at least one object detail;
determining a state of the object based on the input content and the at least one object detail;
determining position of a plurality of physical features of the object based on the shape of the object;
determining an emotion depicted by the object using the state of the object; and
generating the imaginary avatar of the object based on the shape of the object, position of the plurality of physical features, and the determined emotion.

14. The method as claimed in claim 13, comprising:
determining textual information about the object using the at least one object detail;
converting the textual information into a speech; and
generating an audio for the imaginary avatar using the converted speech.

15. The method as claimed in claim 14, comprising:
animating the imaginary avatar by controlling motion of the plurality of physical features of the imaginary avatar in sync with the generated audio.
